(19) United States
(12) Patent Application Publication
(10) Pub. No.: US 2020/0372376 A1
(43) Pub. Date: Nov. 26, 2020

(54) Elegant Reasonism: methodology, process, technologies, and epistemology to view and engage real reality of a unified Universe.

(71) Applicant: SoIREI, Inc., West Palm Beach, FL (US)

(72) Inventor: Charles Curry McGowen, Boynton Beach, FL (US)

(73) Assignee: SoIREI, Inc., West Palm Beach, FL (US)

(21) Appl. No.: 16/405,134

(22) Filed: May 24, 2019

(51) Int. Cl. G06N 5/04

(52) U.S. Cl. CPC G06N 5/04; G06N 3/08

(57) ABSTRACT

This patent, Elegant Reasonism, holistically integrates necessary discrete methodology, process, tools, technologies, the associated epistemology, employs a plurality of INTERPRETIVE MODELS of the Universe (one of which is required to close to unification) and may also integrate both logical and physical views that are encapsulated, enumerated, iterated, such that their relative and respective ‘CONTEXTS’ are captured (ENCAPSULATED) and otherwise contained and then juxtaposed relative to each other SO that the context of one model may be ‘MODE SHIFTED’ into the context of another relative to and respective of an investigative set of ‘neutral’ “paradigms of nature” (PARADIGMS OF INTEREST) which then holistically seeks ‘TRUTH’ as a function of the real unified Universe. Taking into account the logical nature of relative and respective models, the complete composite set of which (including the paradigms of interest) is then holistically positioned against analytical layers consistent with quantified objectives and goals of an investigation; which may include and require ISO 9000 QMS standards, Bayesian Statistics, Six Sigma, and other analytical tools for insight development, holistically in TREATISE, relative to and distinct from the actual real unified Universe. Any discrete factor taken in isolation may lead to erroneous conclusions ultimately not in alignment with Elegant Reasonism. Elegant Reasonism in its ideal form is standards based and aligns with the unified Universe. Simplistic forms of the utility process may serve more simple purposes or to act as ‘proof of concept’ for ideas.

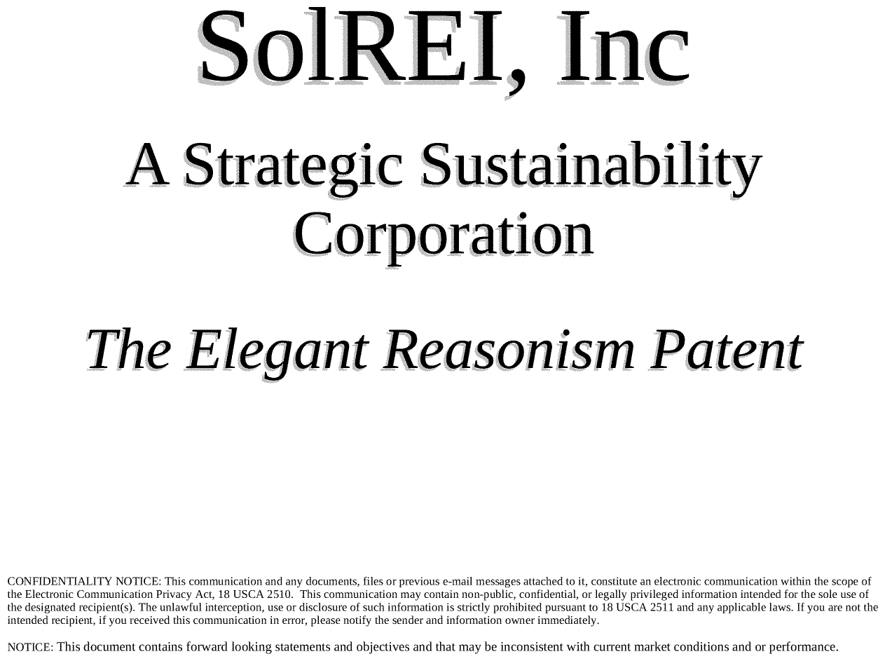

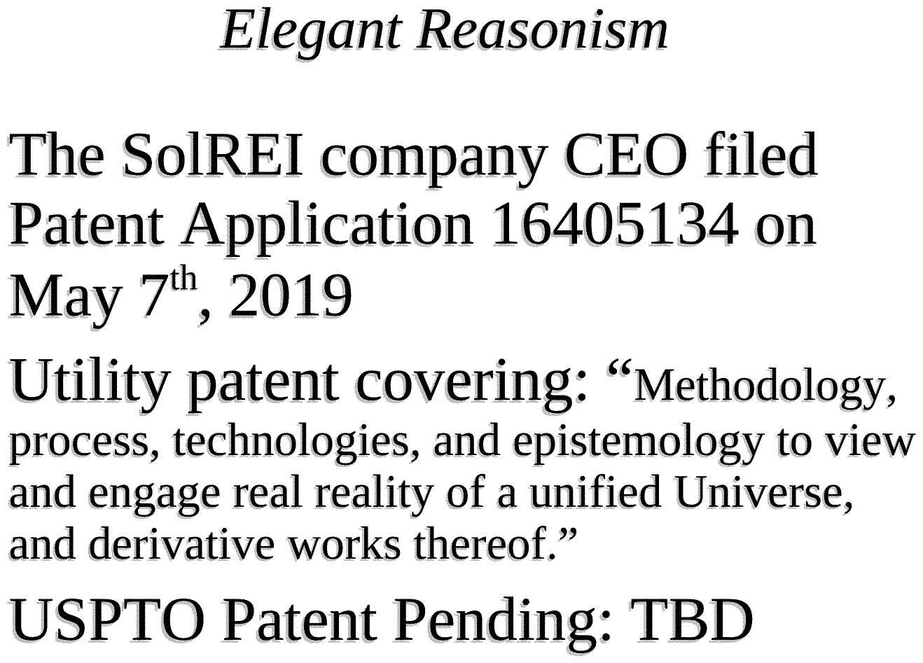

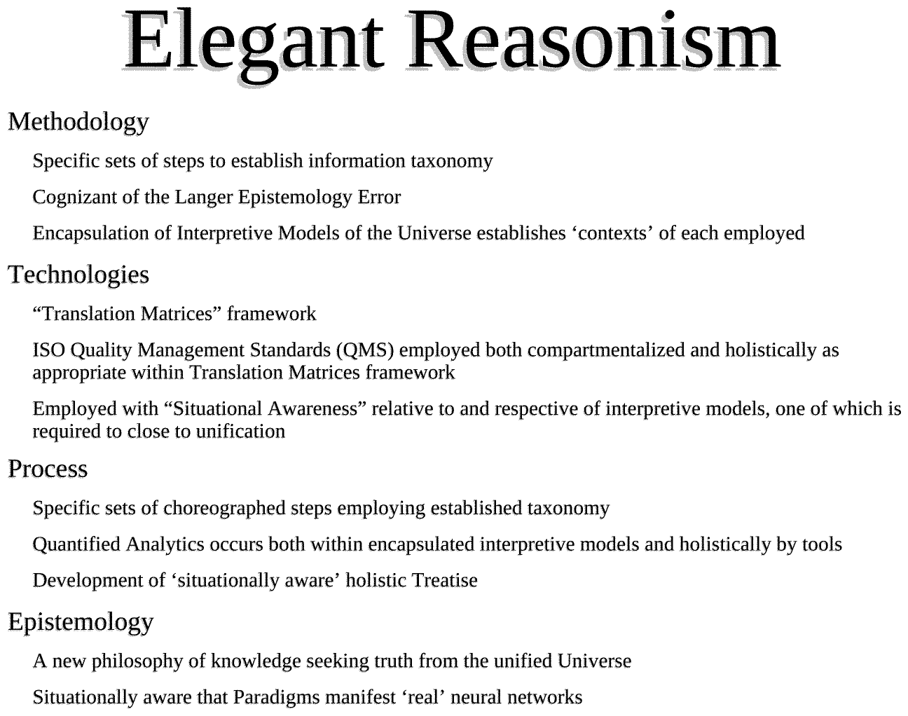

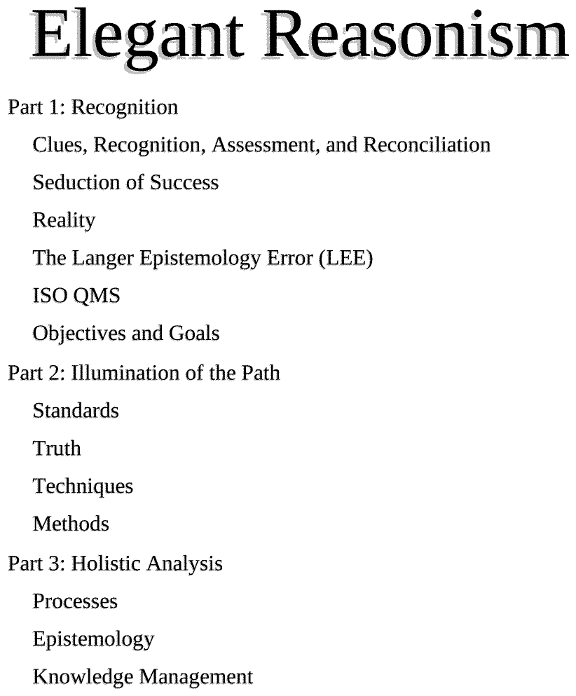

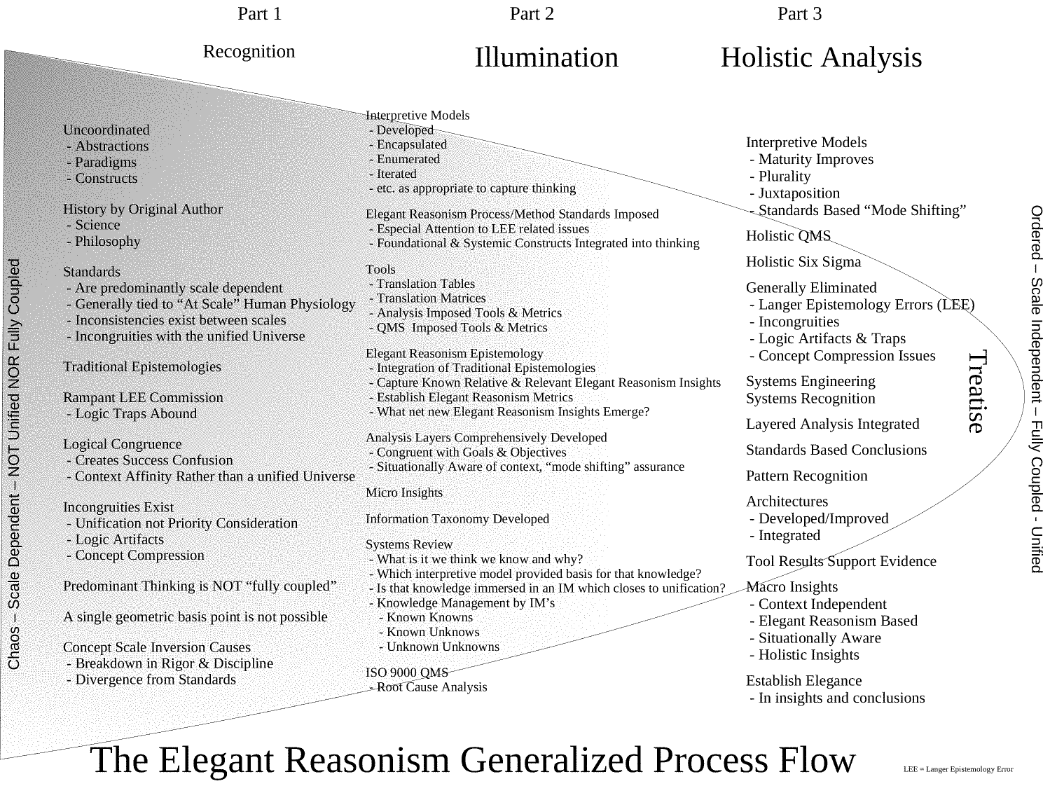

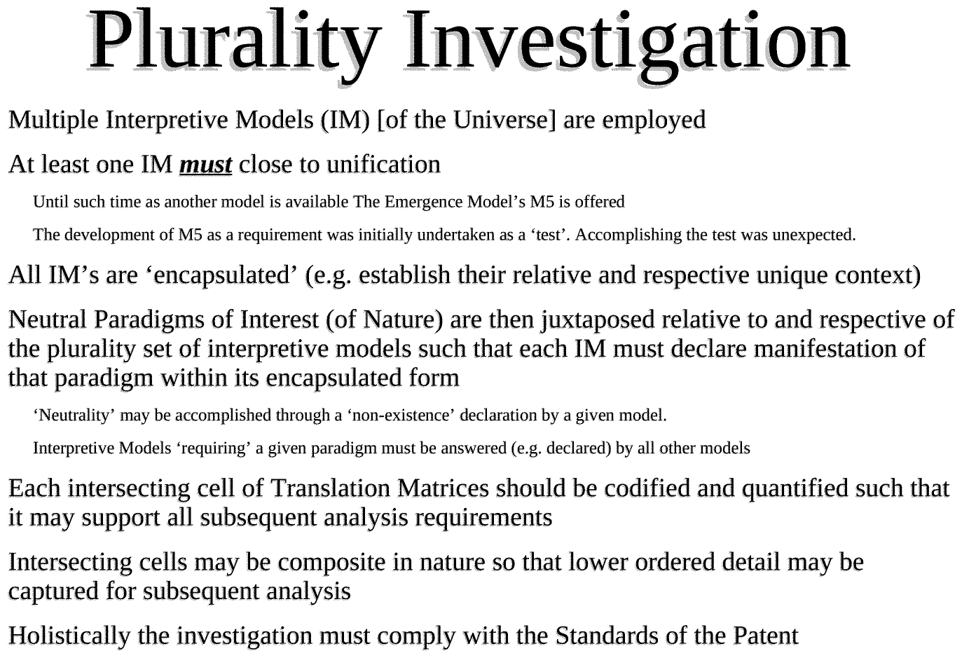

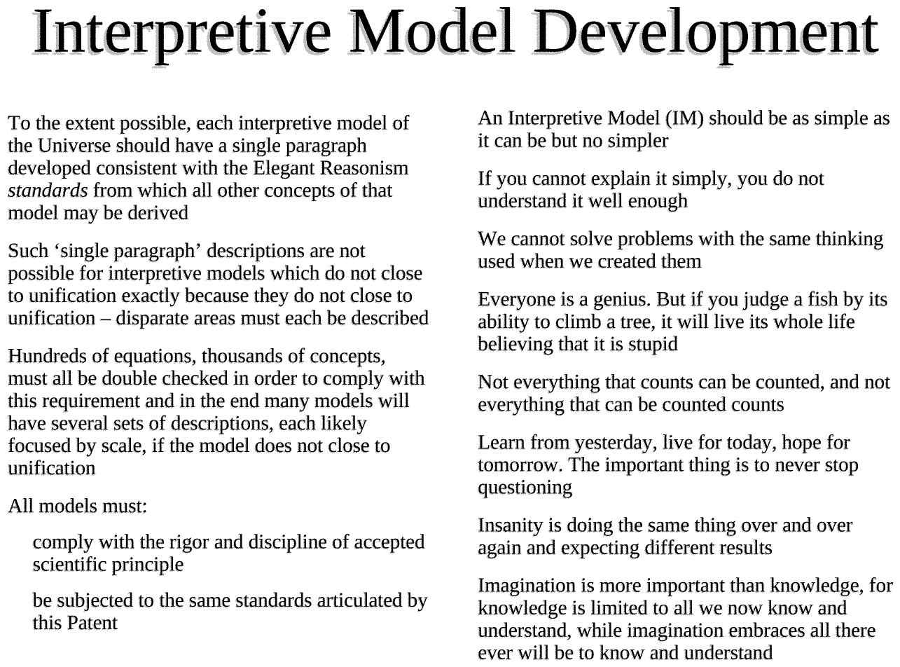

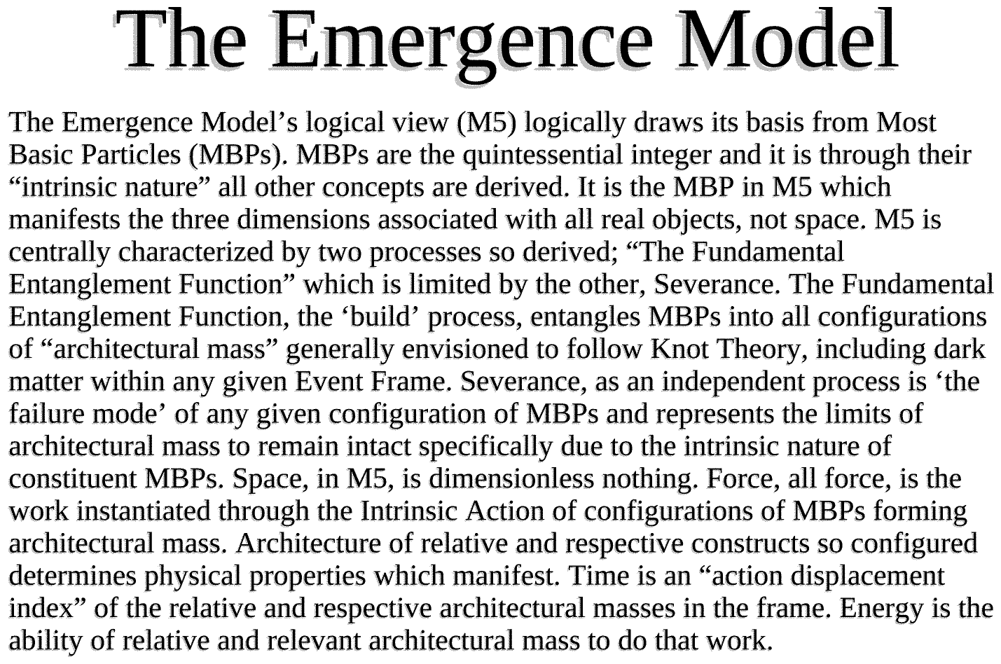

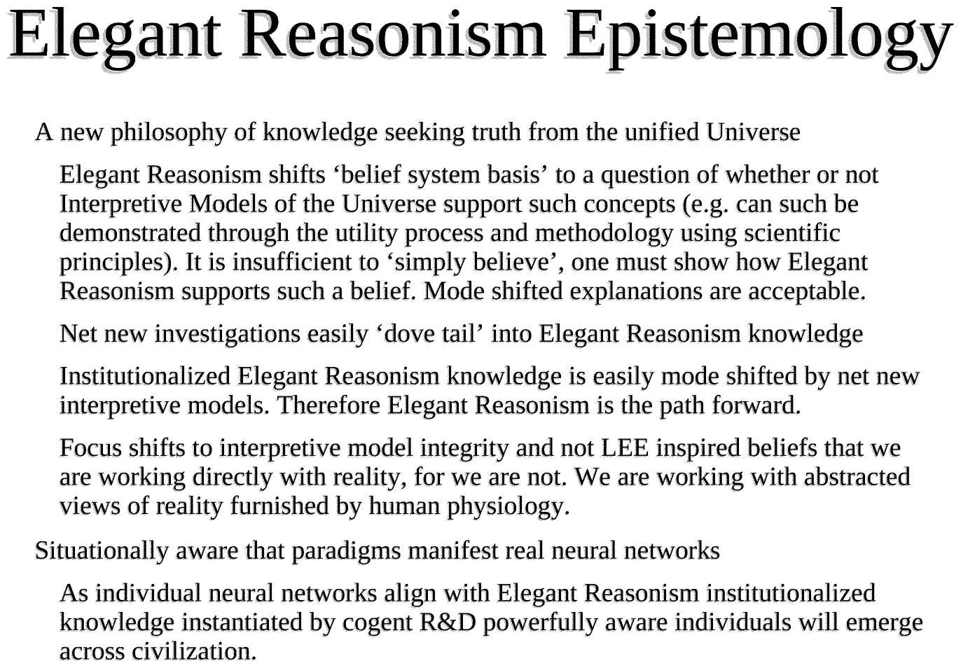

### BACKGROUND OF THE INVENTION

“IN DISQUISITIONS of every kind, there are certain primary truths, or first principles, upon which all subsequent reasonings must depend. These contain an internal evidence which, antecedent to all reflection or combination, commands the assent of the mind. Where it produces not this effect, it must proceed either from some defect or disorder in the organs of perception, or from the influence of some strong interest, or passion, or prejudice. Of this nature are the maxims in geometry, that “the whole is greater than its part; things equal to the same are equal to one another; two straight lines cannot enclose a space; and all right angles are equal to each other.’

Of the same nature are these other maxims in ethics and politics, that there cannot be an effect without a cause; that the means ought to be proportioned to the end; that every power ought to be commensurate with its object; that there ought to be no limitation of a power destined to effect a purpose which is itself incapable of limitation. And there are other truths in the two latter sciences which, if they cannot pretend to rank in the class of axioms, are yet such direct inferences from them, and so obvious in themselves, and so agreeable to the natural and unsophisticated dictates of common-sense, that they challenge the assent of a sound and unbiased mind, with a degree of force and conviction almost equally irresistible.

The objects of geometrical inquiry are so entirely abstracted from those pursuits which stir up and put in motion the unruly passions of the human heart, that mankind, without difficulty, adopt not only the more simple theorems of the science, but even those abstruse paradoxes which, however they may appear susceptible of demonstration, are at variance with the natural conceptions which the mind, without the aid of philosophy, would be led to entertain upon the subject.”
Hamilton, The Federalist Papers: No. 31
   Jan. 1, 1788

### A Special Note Regarding Albert Einstein

Nothing contained herein is intended to detract from the body of Albert Einstein's work in any way. To say he was ‘wrong’ is erroneous. He was logically correct, its just that until this patent application, humanity did not then comprehend what that meant (e.g. to be ‘only’ logically correct). This patent reconciles incongruities associated with the inability to fully couple reference frames and employ a single geometric basis point representing {real} objects and {real} circumstances. Many have problems contemplating not only his work today but what follows on these pages. If anything this patent is intended to elevate and celebrate Einstein's genius. Many people over the years have extended him deserved great credit. We must however, in the name of science, pursue dispassionately the issues plaguing the modern body of science, namely “what is [and now we may employ past tense] preventing us from unifying physics.” Einstein himself once said “We cannot solve problems using the same thinking we used when we created them.” He was more correct than even he knew. We could not then, nor can we now. We must break the cycle and free our minds from age-old logic traps that were completely unanticipated by everyone. Everyone except, it seems, one Susanne Katherina Langer.[1]

### Elegant Reasonism Skills

The skill set needed for Elegant Reasonism is daunting and spans science, business, industry, and philosophy. Among those sciences include, but are not limited to; astrophysics, astrominerology, cosmochemistry, information sciences (especially Knowledge Management and Systems Engineering), geology, particle physics, and theoretical skills are also very helpful. Key among these ‘discipline based’ skills are “critical thinking” skills that are capable of applying the STANDARDS articulated herein across the spectrum of Chart 5 in the presentation deck (e.g. ‘DRAWINGS’, submitted with this patent application) and paying very close attention to THE LANGER EPISTEMOLOGY ERROR [1], logic artifacts, concept compression issues, and potentially ‘logic traps’ from which the only escape is Elegant Reasonism.

### The Langer Epistemology Error

Susanne Katherina Langer, in her book “Philosophy In A New Key, A Study in the Symbolism of Reason, Rite, and Art”, February 1948, 255 pages, published by The New American Library[1] essentially observed that: “The world of physics is essentially the real world construed by mathematical abstractions, and the world of sense is the real world construed by the abstractions which the sense-organs immediately furnish. To suppose that the ‘material mode’ is a primitive and groping attempt at physical conception is a fatal error in epistemology”. [1] The body of work this patent represents, honors Langer by naming the epistemological error after her. We are not aware of anyone in history making this observation prior to Ms. Langer and it is vital to this patent application. Until Elegant Reasonism, commission of this error has been anything but ‘obvious’. Humanity lulled itself into believing it was working directly with all that is, and it is not; rather, it is working with that part of reality our physiology perceives. In order to work with all that is requires Elegant Reasonism, and again realizing that, is not obvious. If it were it would not have taken until this patent to realize the issues and challenges.

‘Abstractions’ essentially, insulate and isolate higher ordered ideas, and concepts, from lower ordered detail. Therefore it is vital to prioritize systemic concepts in any given interpretive model of the Universe as a function of their intrinsic relationship to everything else. This places the highest priority on the most fundamental, core, concepts. The implications of commission of the Langer Epistemology Error is confusion between ‘abstractions’ and the reality they are meant to describe. Traditional empiricism, as an epistemology, ultimately is constrained by human physiological abstractions Langer spoke of in her book [1] and combined with modern information sciences we realize the depths of that issue. When we enumerate and prioritize 100% of the various facets of any given encapsulated interpretive model of the Universe we must recognize, through critical thinking, distinctions between “context congruence” (established by any given interpretive model of the Universe within its relative and respective encapsulated form) and “alignment with reality that is unified” (even if our understanding of it is not).

Never must we ever claim that we are directly describing real reality. What we are doing in any description is describing how we think it works not how it does work. The reason for this distinction is simple—the actual real mechanics are beyond the threshold of perception. Human perception is constrained “at scale”. Models incapable of spanning all scales, failing to employ single geometric basis points for all real objects in the same frame, and failing to fully couple all fundamental forces should be held with great skepticism and doubt. Minimally they should be considered logical in nature. Turning this around then illuminates the path out of logic traps otherwise ensnaring investigations.

### Recovering from a Langer Epistemology Error

The first step in recovering from such an error is realizing that you are ensnared in the first place. The process of that realization is, in one way, what this methodology patent is all about. It is about organizing epistemological core elements to their most fundamental constituents and then comparing them, and their behaviors, against the unified reality held litmus. We must remember that we are always working with an interpretive model of reality and not reality itself. Reality itself must always be held apart and separate from our considerations of it, if for no other reasons that we (ourselves) are intrinsically a part of what is. Holding reality apart and distinct in this manner requires the employment of another critical element of the holistic process being described herein, and it is ‘interpretive model encapsulation’ and is discussed elsewhere. Here we mention it only as a requirement because it leads to enumeration of interpretive models. The reason this is so stems from the fact that if our predominant thinking does not “unify physics” and we must recognize that the actual real Universe is in fact unified, then we must recognize that our thinking about it is the problem. Realization of THE LANGER EPISTEMOLOGY ERROR illuminates the process steps necessary to recover and exit the error (averting commission being fatal). Such a recovery inevitably involves Elegant Reasonism. Once interpretive models are properly encapsulated, enumerated, they must be analyzed and that's where the remainder of this patent application is brought to bear on those issues.

### DESCRIPTION OF ART/DRAWINGS

Elegant Reasonism is an information science based method, process, technology, and epistemology. It's “process flow” is depicted using concepts represented by language references forming symbolism. Such symbolism represents large bodies of knowledge employed in a unique manner consistent with this patent.

### FIELD OF THE INVENTION

There is no human endeavor that this patent does not touch or influence in some manner. This patent can be used to describe the entire Universe “Bang to Bang” (and everything in it). The present invention relates to the necessary epistemological considerations, tools, technologies, concepts, methods, processes, techniques, necessary in order to comprehend, engage, apply, and align with—a unified view of reality (e.g. the unified Universe) for the purposes of enabling civilization to employ this method in pursuit of derivative works similarly aligned. Because the actual real Universe is unified, and this process results in the utilization of encapsulated interpretive models that are also ‘unified’. Elegant Reasonism integrates a net new epistemology whose truth is derived from a unified view of reality (e.g. the Universe). Concepts incongruent with that aligned view are inconsistent with Elegant Reasonism.

This application focuses on the methods, processes, technologies, and epistemology needed to accomplish utility of the claim for the purpose of pursuing works derived thereof. One exemplary result of having employed this patent is included herein and is entitled: The Emergence Model which does “unify physics” among other human endeavors. As an epistemology it unifies philosophy and science. Because The Emergence Model's logical view M5 integrates action we can observe linkages to Ludwig von Mises's view of economics. Because of the intrinsic processes and their interactions across Event Frames we may observe the basis of Evolution across all frames. Simple observation of M5's definition will yield the reasons Newton's Laws are true. The mathematical sciences, especially geometry, are revitalized due to the ability to use any MBP, or set of them, as a geometric basis point in any frame. Unification holds a great deal more implications than just the science of physics and these few examples.

Because this patent recognizes, presents, and engages a “unified view of the Universe—and everything in it”, there is by definition, no human endeavor it does not touch in some fashion because our existence is within that domain of discourse. This patent is not about ‘physics’, nor the ‘physical sciences’ per se. This patent is holistically about the processes needed to employ all of philosophy, science, business, and industry necessary to comprehend the processes of a unified realm and the methods involved, so they may be engaged and subsequently applied under license with guidance as determined appropriate. Elegant Reasonism seeks truth from the unified Universe. Traditional epistemologies are necessary, but insufficient, to deal with issues of unification exactly because of the constraints imposed by human physiology. Human physiology imposes a threshold beyond which our sense organs fail to perceive resulting in our neural systems (and brain) furnishing ‘abstractions’ in order to relate to the real world around us. Elegant Reasonism integrates interpretive models of unified reality in order to gain precipice of the unified Universe in which civilization, and humanity, exists. Susanne K. Langer was the first philosopher [1], known to this inventor, who recognized this problem and the Langer Epistemology Error is named after her for that reason. Charles C McGowen, circa 2005-2006 independently of Langer made the same observation as Langer resulting in a corroboration of the error. Since Langer's observation was in 1948 and McGowen's decades later that ‘type’ of error herein is named her honor.

What this patent does not do is deal with the plethora of preconceived ideas, which in most cases are examples of the Langer Epistemology Error, or logic traps of one sort or another. While we have material dealing with such information, some of it outlined herein, it is generally not included here for the sake of brevity and USPTO filing rules. Humanity has never before immersed such a view simultaneously consistent with scientific principle, philosophy of knowledge, and applied R&D, each of which spans the spectrum of human endeavor and all scales. The methods, practices, tools, and technology articulated herein accomplish this task. There are essentially three parts to this patent technology; PART 1: RECOGNITION, PART 2: ILLUMINATION, and PART 3: HOLISTIC ANALYSIS. See Chart 5 in the DRW file submitted with this application for a generalized overview of the process and these three parts in context of one another.

One need only review recorded history where humanity has worked to unify science such that everything real may be derived from one cogent, concise, set of words and rules to comprehend that until this patent application filing that effort has been in vain. Such a paragraph is included herein describing The Emergence Model's Logical View M5. This patent is unique in history because it accomplishes exactly such a cogent paragraph and discloses the methodology by which it was achieved. This unique and distinct method, process, and utility establishes the manner on which it may be improved upon by future investigators. This historic accomplishment required novel insights to be developed. It borrows much from many disciplines of science and philosophy. It is a collection of methods. It is a process. It is an epistemology. It has techniques and it has rules. Collectively and holistically they form what this patent calls: Elegant Reasonism.

History records that the information technology industry developed after critical foundations for physics were laid. In 1905 when the nascent beginnings of current predominant thinking (in physics) were initially put forth, no one on Earth had any concept of modern Systems Engineering or the concepts it employs. The information sciences discipline of Knowledge Management had not been invented and certainly not framed in epistemology. Systems Engineering as a profession, practice, and process was not formally established until about 1990 when the International Committee on Systems Engineering (INCOSE) was formed. Consequentially it should come as no surprise that the priorities on unification criteria should have come as first order business in establishing any interpretive model of the Universe rather than as an afterthought (as history actually records). Predominant thinking, as a direct result of these misaligned priorities conspire to manifest as a “logic trap” of epic proportions. Directly as a result of those misaligned priorities humanity committed what our body of work calls “THE LANGER EPISTEMOLOGY ERROR” (LEE) [1], after Susanne K. Langer who, in 1948, was the first philosopher to recognize the error. Only with the filing of this patent application is the scope and magnitude of humanity's commission of that error illuminated.

### Why this Patent is Required

This patent is required because predominant thinking does not, and cannot, unify physics. Worse yet is that predominant thinking believes that with further R&D that maintaining the status quo in that thinking will ultimately reconcile the issues. The central issue is how the fundamental abstractions employed by such thinking conspire to create a “logic trap” preventing and precluding the ability to perceive the actual real unified Universe. Elegant Reasonism provides a framework, employing specific methods, processes, technologies, and an epistemology needed to view and engage the actual real unified Universe. Elegant Reasonism is the only known utility method known capable of illustrating and illuminating the factors which resulted in the modern inability to unify philosophy and science. Resources are funneled to efforts to that end. R&D which produces greater or improved results which reinforce status quo thinking are lauded with great applause. Sigma values are touted as ‘proof’ of success. What's wrong with these approaches? Plenty.

How did we get where we are? Essentially global civilization fell prey to what we call THE LANGER EPISTEMOLOGY ERROR. Why that happened was a happenstance of circumstance in as much as people fell prey to the error prior to the error even being recognized. Certainly before information sciences were ever even recognized, much less developed. So through no fault of theirs these people were essentially acting unaware they had committed the error. We cannot fault them because until this application filing very few others realized it either. Basically everyone is guilty of committing the error, including this inventor; which is what motivated the development of the body of work this patent represents. Simplistically this patent ‘wraps up’ manners of thinking about the Universe (e.g. M1 through M7), codifies them, enumerates distinctions, creates a taxonomy for them, juxtaposes them in a manner neutral relative to investigations, then analyzes them, and then develops a treatise based on that analysis. The uniqueness manifests through application of information sciences, ISO 9000 QMS standards, epistemology, and a healthy doses of rigor, discipline, and critical thinking. This patent is required because predominant thinking is defined by M1 and M1 is a logic trap. Not only does it not unify physics—it never will, and that's a problem. The implications of this circumstance is that billions of US Taxpayer resources across the economic spectrum are being wasted in pursuit of an objective that is elusive for a very good reason. That reason is the core constructs conspire to preclude unification. M1's spacetime-mass interface cannot be transitioned absent conversion to energy and that circumstance precludes unification. It's just that simple. M5 is defined in a very different manner and derives its basis completely different from M1. M5's definition eliminates such issues and closes to unification in an intuitively obvious manner. M5 is simpler and does not require any advanced credentials to comprehend. More importantly M5 enables methodologies which focus US Taxpayer resources across the economic spectrum in a more effective and efficient manner and does so consistent with a unified view of reality. These circumstances ripple across Human Action [2] empowering the economy. In systems reviews these distinctions may or may not have direct consequences that are superficially evident. However, deeper dives into enterprise operations and engineering considerations almost always produce enhanced comprehension resulting in improved application of the sciences to problem solving. Philosophical pursuits find their results just as shifted when based on Elegant Reasonism as an epistemology because what constitutes truth shifts. Because of these issues what constitutes “evidence” fundamentally gets redefined exactly because Elegant Reasonism is not shackled by human physiological constraints and because it employs advanced analysis processes and protocols in context of a plurality of interpretive approaches to attain perspective on the unified realm in which we all exist. Salient to these revelations is the fact that this patent affects, likely directly, every other patent ever filed and certainly every patent filed after this patent. Consequently the USPTO will need to comprehend the implications of this patent in order to assess this patent's validity. That this patent produced M5, which does in fact unify physics in an intuitively obvious manner, suggests the USPTO can come to no other conclusion than to grant this patent claim. Using this patent in this manner only reinforces that point.

### Overview

Elegant Reasonism requires a plurality of interpretations to view reality in a unified manner (which simultaneously illustrates not just what works, but what does not and why), but employs the methods, practices, tools, and technologies which together may be regarded as the means ‘the unification of physics’ is achieved, investigated, and improved upon. Saying that this ‘unifies physics’, while true—considerably constrains and restricts its true accomplishment. While this ‘method patent’ did produce an interpretive model which does unify physics it does not claim other, potentially better, models cannot also be produced using these same methods. What is being claimed is that all such investigations will follow substantially similar methods, practices, and processes forming the essential point of this patent application. There are in essence three parts to this patent application:
1. RECOGNITION of the implications, in context of the problem being investigated, that predominant thinking does not unify physics, nor science, nor science with philosophy. The question then becomes: Why? One may ask why areas of human endeavor not dealing directly with ‘physics’ should care about this and the answer lay in the epistemology of truth. Elegant Reasonism seeks truth aligned with a unified view of existence.
2. ILLUMINATION of the problem via the Langer Epistemology Error [1]. This gives us many of the situational awareness insights necessary to establish tools employing analytical frameworks credibly capable of supporting systematic analysis across the various domains of discourse in context of the governing rules herein, and
3. HOLISTIC ANALYSIS developing insights in Treatise

### Elegant Reasonism Insights and Rules

What is here was hard won through the body of work (an early systems review) that became Elegant Reasonism and this patent. The Emergence Model of Particle Physics is an Elegant Reasonism derivation of The Standard Model of Particle Physics. To perceive the derivation one would have to immerse both in this process and MODE SHIFT “model to model”. While the source of many of the facets of the process and method being patented here exist externally in industry, never to this inventors knowledge have they applied to science disciplines themselves. This inventor is not aware they have ever been applied to the approach needed to unify physics. What you see here resulted from exactly those types of efforts:
1. Elegant Reasonism requires the STANDARDS herein be rigorously applied with disciplined situational awareness from the most fundamental elements to the most complex of each and every relative and respective interpretive model of the Universe employed and the various constituent concepts therein. This means those standards must be isotropic across all scales and orders of complexity. They must apply holistically to Translation Matrices to the extent humanly possible to articulate. These same standards must apply to the application of the various employed processes due to the fact that interpretive models of the Universe define the manifestation of core interpretations both foundational and systemic to every other contemplation associated with real systems, and many virtual systems, employed by humanity. Virtual systems modeling real systems should conform to the same criteria as those employed by Translation Matrices modeling the real unified Universe and held to the same standards.
2. Elegant Reasonism as an epistemology is capable of dealing with both logical and physical views of constructs comprised of complex composite abstractions. However, its Essential Truth is derived from the Real Systems that are, or are in, the unified Universe. Elegant Reasonism as a method, process, tool set, and epistemology employs a plurality of interpretive models of those real systems, minimally, one of which must close to unification. Logically correct models which do not close to unification remain useful tools in Elegant Reasonism as they assist investigators in positioning underlying details of the abstractions employed by that model. Such models often (today) reflect ‘what we currently think we know’. For example, M1, does not close to unification. The incongruousness of M1 may be thought of as a ‘clue set’ which must be solved by a model which does close to unification, in this case M5. We may further exemplify the subject, science, and discipline of ‘geometry’. M1 is fundamentally incapable of representing its geometric basis. The historic rationalization for this incapacity is the infinite (or vastness) of ‘space’ makes this requirement irrelevant, but that rationalization is erroneous. M5 reconciles this as its fundamental derivation manifests from a ‘Most Basic Particle’ (MBP). M5's MBPs, or sets of them, act as geometric basis. While civilization has made great strides employing the logical correctness of M1, we must also face the reality that not only does it not unify physics—it never will. Civilization has fallen prey to THE LANGER EPISTEMOLOGY ERROR [1]. M1 is a logic trap of epic proportions. Why M1 will never unify physics may be distilled down to the spacetime-mass interface transition precludes achieving the requirements of unification. What we forgot is that in every case our interpretive models of the Universe must ultimately describe “Real Systems” and employ ‘real’ elements regarding the mathematical sciences we employ. Throwing away the geometric basis requirement of M1 relegates that interpretive model into the realm of ‘logical systems’. M1 is a logical representation of a real system it is not ‘the’ real system and therein was how civilization committed THE LANGER EPISTEMOLOGY ERROR. Its success is a function of how correct that representation has been to date, but it is still only a logical representation of what is. Getting out of M1's logic trap requires Elegant Reasonism and at least one interpretive model which closes to unification, and M5 is such a model because everything real may be made manifest through its simple description, from the simplest MBP to the most complex super-galaxy inclusive of its core supermassive black hole. M5 connects quantum mechanics and cosmology through orders of complexity associated with configurations of MBPs into complex composite architectures of mass. The instant we employ ‘thought experiments’ should give us great pause to consider the very nature and character of our various investigations and on what, exactly, they are based. Ultimately we must conclude that it must be some real system derived from the real unified Universe. The real Universe ‘is’ unified.
3. Realize Priorities. The system review conducted which spawned this patent found that information science priorities were out-of-order necessary to derive unification and ultimately that was civilization's error. In short, we committed THE LANGER EPISTEMOLOGY ERROR [1]. All of us, everywhere and for more than 100 years, including me, until this body of work was undertaken. I just happened to stub my toe on the answer. Any given interpretive model of the Universe should start with a description constrained to a single paragraph conforming to the STANDARDS described herein. The paragraph should be constrained to a single sheet of paper and no longer. Einstein said “If you cannot explain something simply enough, you do not understand it well enough”. The Emergence Model's logical view is explained in a single paragraph (0144) on page 105 herein as a matter of predominant priority superseding all others. Now, having said that, I cannot impose a requirement that such a paragraph be written before any other developmental work on a net new model be undertaken. I cannot because that is not the manner in which The Emergence Model was developed. That paragraph describing it herein had to be reverse engineered out of the body of work resulting in this patent. Now, having the paragraph was always a hard requirement, but it took a decade of hard work in order to develop that paragraph. It did not come easily, but having it was always a goal and objective. If such a paragraph cannot be written conforming to the standards herein one should view such a model with great skepticism, pause, and reflection.
4. Details matter. Abstractions have a tendency to insulate and isolate higher ordered ideas from lower ordered details and those details may, in of themselves ‘be’ abstractions further distancing dependent concepts on foundational details. ‘Cells’ within Translation Matrices should be considered essentially composite areas that are parsed as finely as required in order to quantify manifestation of the paradigm of interest. Where those details represent abstractions demanding increased resolution Critical Thinking and Situational Awareness become priority skills. “Detail sets”, a knowledge management concept, content may change across the plurality spectrum of engaged interpretive models because the context changes. Readers are cautioned to thoroughly comprehend implications of ‘mode shifting’.
5. The information sciences discipline of Systems Engineering teaches us that all interpretive models [herein of the Universe] minimally have a logical view and a physical view. The Emergence Model is no different. M5 is the logical view and M6 is the physical view. However, it is of critical import to know that logical views have greater precision than do physical models because there is always more than one way to accomplish something physically. Logical views have precise expectations both in terms of inputs, processes, and results. For this reason the vast majority of work effort to date has been on M5 rather than M6, but both exist and are ultimately expected. While we are where we are, it is critical to remember that our models are just that and never, ever, do we claim we are describing “actual” {Real} Reality. What we are doing is ‘modeling’ reality in an attempt to find a model that aligns with a unified view of it. {Real} Reality is always held apart as litmus. In M5, ‘everything’ is a system or system of systems.
6. All interpretive models should, ultimately, detail how they manifest core constructs and concepts, physical properties noted by science, across the same requirements as the Systems Review conducted which produced The Emergence Model. Some 403 equations, 167 propositions, 63 thought experiments, historical research from many other notable scientists throughout history were reviewed in the systems review which ultimately produced this patent. We have well over 2,000 pages of insights resulting from our investigation using the methods articulated in this patent. Any subsequent interpretive model following this patent will be required to comply with similar rigor and discipline. Our systems review followed the method, process, practice, and tools outlined herein spanning these various checks and balances to produce the final results shown in Treatise.
7. A systems review of M1's dimensional limitations prove to be a ‘Logic Artifact’ of the definition of that model. M5 dismantles such limits elevating Hubble's original observations thus eliminating the need for ‘expansion of space’ parameters like the z-factor. The implication of this is that the Universe and our Particle Horizon are very much larger, and older, than we thought. The point of this rule is to be situationally aware of how logic artifacts manifest and the clues they leave behind. If we are so impassioned by our belief system that we are incapable of perceiving such clues then individually we should take great pause for reflection and reconciliation of our own paradigms and epistemology.
8. The process, concept, and formation of “model encapsulation” creates the ‘Context’ of each interpretive model employed. This means manifestation of phenomena is discrete and unique by model. This is one reason ‘paradigms of interest’ must be “mode shifted” model to model, in order to convey contextual changes and their implications. Encapsulation also means that no model may be explained in context of another. Because basic ‘thinking’ is a function of ‘context’ established by a given model thinking must also be mode shifted model to model. Another implication is that the mathematics of M1, for example, do not work in M5, and the reverse is also true. However, the mathematics within each relative and respective encapsulated interpretive model retain their integrity. We are therefore able to assess and fully analyze both internal to encapsulated interpretive models and externally through the analytical capabilities of Translation Matrices.
9. The implications of Model Encapsulation are not intuitively obvious at first encounter. Because the comprehensive set of abstractions, constructs, paradigms, and rule sets change model to model—switching from one model requires what Elegant Reasonism refers to as “mode shifting”. Looking at Table 2: 2D Articulation Table Generalized Construct on page 52 the reader should be aware that “context” is ‘column centric’ for the various interpretive models employed and ‘row centric’ for the ‘paradigms of interest’. One area of ‘awareness’ is that of mathematics. While the mechanics of mathematics is isotropic across all Translation Matrices, the thinking that goes into various equations is not. That is to say the meaning behind the parameters is not consistent. Variables may hold different meanings and must be “mode shifted” as appropriate. For example the mass-energy equivalence equation in M1 does not include ‘intrinsic action’ but it does in M5. Also, in M1 the variable “c” refers to the speed of light, but in M5 it refers to the Severance value of photons which results in that velocity. Such difference demand vigilance, rigor, and discipline. In M1, velocity is limited by the “dimensional nature” of spacetime, in M5 there are no limits and velocity is a function of Rapidity (e.g. Beta—p). Interestingly, maybe ironically, particle beams on Earth align those beams using Rapidity. There are clues all over that have been in front of us all along. So this rule is to assure ‘model integrity’.
10. Elegant Reasonism seeks Truth aligned with a unified view of the Universe, and consequently, belief systems based on this epistemology are also so aligned. Other epistemologies, and belief systems, must be mode shifted relative to and respective of the unified Universe.
11. Once Translation Matrices employed by an investigation team are properly configured and completed what they will find across the interpretive models relative to their paradigms of interests is a “Simultaneity of Truth”. That is each interpretive model of the Universe simultaneously manifests ‘logical truth’ (relative to each respective interpretive model). The distinction is that the logical truth is in context of the model manifesting it. A greater insight then is that ‘unification priorities’ must be a “first order business” when considering any net new interpretive model.
12. Keep Translation Matrices as simple as they need to be. Simplicity should be an over arching goal behind the need to be CONCISE. Do not over complicate investigations with unneeded detail. However, if you are not sure or do not understand relationships then pursue the detail to the degree needed. Remember, that abstractions tend to insulate and isolate higher ordered concepts from lower ordered detail, so the needed detail to make a point may be hidden in that lower ordered detail. Once clarity is attained—then strip away the parts that do not make your point or do not support the investigation unless telling that story is required in order to make your point. Then by all means keep as much detail as is needed; however, be situationally aware of all the STANDARDS to which any investigation should conform.
13. Because another model does not unify physics does not mean it is not useful, nor does it mean it is necessarily “wrong”. It is not fair, nor proper, to say that Einstein was ‘wrong’, he was not. Einstein was simply logically correct within the definition he gave (e.g. M2). What it means is that such a model is likely [only] logically correct. That may mean the real story must be articulated on a larger canvas of multiple models (e.g. the Plurality Requirement of Elegant Reasonism) or by a model which does close to unification. Investigations often developing new ideas must draw on the thinking of preexisting research and in 2019 that almost always means M1 thinking produced it. However, mapping such research out very often helps illuminate what needs to be done in M5. Very often problems may be ‘surrounded’ or ‘corralled’ in this manner in order for development efforts to illustrate insights.
14. Taking these various insights into account relative to Prioritized Situational Awareness and Critical Thinking we realize that as a first priority the core constructs of any given model must be solidly grounded and synergistic in terms of how the model makes them manifest. M1, for example, must take its core concepts and raise them up one order in order to integrate them. Why that is required is because the model deals most often with this higher order rather than the core concept order. Specifically the higher order “spacetime” is a composite of its lower ordered concepts; each of the four dimensions whose composite constitutes the higher order. Exactly how those lower ordered concepts are connected to the higher order construct is not clear nor has it ever been defined. We know ‘intellectually’ that 3 dimensional space is a composite of constituents whose axis are the x, y, and z components but how they mechanically manifest ‘real’ reality is somewhat fuzzy. When critical thinking requires us to circle back on these concepts and integrate the factors necessary to support ‘warping’ of these three axis constituents the discussion gets even fuzzier. We can describe ‘what’ happens, but that is a logical description not a mechanical discussion integrated with each actual constituent of the construct. Critical thinking demands integration of such factors because the model calls for all mass to ‘warp’ this construct in the manifestation of the phenomena we call gravity. We ignore the implications of the spacetime-mass interface relative to viable (e.g. real) geometry. Ultimately we settle for the logical description and most have completely ignored the clue before their very eyes as to the deeper meaning of that clue and the implications it carries. M5 reconciles these issues by defining them as a function of Most Basic Particles (MBPs). MBPs' intrinsic nature is three-dimensional. The intrinsic action may be considered logically as a forth but can also be considered separately via the action principle. M5 defines ‘space’ as dimensionless nothing, and is therefore irrelevant in every discussion. Configurations of MBPs then form the complex composite architectures of mass whose intrinsic action instantiate the work performed by these architectures. “Physics”, is therefore and thereby unified by M5. The primary purpose of this patent is about the methodologies, processes, and tools needed to accomplish Elegant Reasonism based Treatise. The Emergence Model, both logical and physical, are a bonus also covered by this patent. It is for these reasons that minimally, one interpretive model employed must close to unification, and Translation Matrices employing the pluralistic set of constructs representing each such model must, at some point, integrate the core constructs, abstracts, etc. employed by each model within the set of paradigms of interest so that each model is required to illustrate exactly how that model makes manifest each relative and respective paradigm of interest.
15. Once properly configured Translation Matrices are made manifest by investigation teams, then and only then, may proper Six Sigma criteria be amassed and analyzed exactly because of context mode shifting issues. Calculating sigma defects within an encapsulated interpretive model only serves to illuminate alignment to that context and has little to do with an underlying physical system which may support that logical view. What must be accomplished is a holistic view of the pluralistic approach made manifest by this tool and its analytical layers (and the processes they represent). The Holistic Precipice must be taken into account in order to develop an Elegant Reasonism precipice in Treatise.

### Part 1: Recognition

Vital to the reader of this application to comprehend are several concepts. Some deal with information sciences (especially Systems Engineering), logical views of physical systems and implications therein, ISO 9000 QMS, and others with biology, epistemology, physics, and other disciplines, such as critical thinking. Human physiology is limited and therefore constrains traditional metrics by which we might produce what might otherwise be considered “hard evidence”. Humanity must embrace a larger view that requires employment of its intellect, technologies, and instrumentality with great applied situational awareness. Situational awareness includes concept prioritization employed consistently by a capable epistemology, like Elegant Reasonism. Employed and embraced in this manner we must also realize that there are both logical and physical views of “reality”, but we must include our own human physiology in such situational awareness considerations. The epistemology we employ is keenly aware of human physiological limitations and is able to parse illusory perceptions imposed on us by that very physiology in context of a Universe which weaves a larger tapestry and is unified, whether we think of it that way or not. The first step in solving any problem is recognizing it exists. Regarding the unification of physics the challenge then is to recognize the implications of THE LANGER EPISTEMOLOGY ERROR, so as not to be ensnared by the error nor its implications. This means also that in “Determining the Root Cause—The 5 Why's” must be conducted in a “situationally aware” manner. These technologies and tools in the holistic context herein provide a solid foundation from which to conduct an investigation, but it is only a beginning. We are required to minimally integrate all the remaining into our thinking as well. Elegant Reasonism is many things including but not limited to (e.g. minimally): a process, a method, and an epistemology. This patent establishes the nature of M1 and any subsequent method situationally aware of these issues must be considered a derivative work of this patent.

### Clues: Recognition, Assessment, and Reconciliation

Clues, especially ‘logic’ clues, are notoriously difficult to discern. One need only realize that it took humanity well over 100 years to realize the implications illuminated by this patent to make that case clear. This is nowhere more salient than in the sciences and because we humans are part of the system being defined. Commission of THE LANGER EPISTEMOLOGY ERROR it seems is something we all fall prey to. We are on the inside trying to gain an ‘outside in’ precipice, and it requires our collective intellect to perceive with high fidelity. Logic Artifacts often manifest as incongruent data points, extensive rationalizations, ever more complex elaborations in order to rationalize some description, or other manners. A few examples from M1 might be: the lack of a geometric basis point for spacetime, reconciling the corollaries of ‘rapid expansion’ and ‘infinite compression’ regarding black hole growth vs the Big Bang. An inability to cohesively connect concepts across scales is another clue. Probably the most salient might be the inability to create a unified description of the Universe. There are many examples to be sure and not all require astrophysics to outline. However, one must be able to ‘clear the slate’ across all scales, science disciplines, and philosophies in order to “unify physics”. This is a tall order, but M5 on reflection has arguably [denial is a powerful thing] accomplished that objective (so far). If at some point it is shown to be defective in some manner through ‘clue illumination’, then this method being patented is already situated to be the process by which its successor will be pursued.

Some logic clues arise as what Elegant Reasonism calls: ‘concept compression’. For example finding fully formed great spiral galaxies in Hubble Ultra Deep Field images so far away as to leave no room for formation using normal expected processes between the object and the Big Bang. The rationalization for their existence pressures proponents to claim reduced (compressed) formation times. Traditionally, especially when commission of Langer Epistemology Errors have been made because the associated belief system is that the investigators are ‘working with physical reality’ when in fact they are working with a logical representation of it, such clues would send teams off to pursue more elaborate or larger experiments to ‘gather more data’. The spacetime-mass interface of M1, M2, and M3, conspires with such logic artifacts in essence to create a ‘logic trap’ from which there is no escape save Elegant Reasonism. And it is for this reason that the USPTO must use Elegant Reasonism to assess the validity of this patent (e.g. the USPTO must use this patent to assess itself). The inventor is ready, willing and able, to work with the USPTO in that endeavor and to that end for the benefit of civilization.

Elegant Reasonism creates a set of conditions juxtaposing a pluralistic set of interpretive models relative and respective of a set of paradigms of interest and then also to an array of analytical layering in order to develop insights illuminating logic traps and concept compression issues. Once such problems are illuminated they are investigated through mode shifting across and into unified interpretive models for reconciliation of what must be. The inventor's experience is that this is the only way, so far discovered, to escape such logic traps because context is established as a function of the encapsulated interpretive model (and we are inside that construct). Only through pluralistic penetration by paradigms of interest are logic traps exposed for what they are. As a matter of priority, paradigms of interest focus on the core constructs of all interpretive models such that their logical nature is clearly exposed and otherwise illuminated. M1, M2, M4, and M5, are all logically correct models; however, only M5 closes to unification. Building Translation Matrices focusing on the intrinsic nature and character responsible for manifesting these models such that their respective pros and cons are illuminated for analysis yields encyclopedias of insights.

### Seduction of Success

Modern civilization has made great progress leveraging the predominant thinking of science, specifically: physics. Problem: “Modern science, as of 2019, has not been able to ‘unify the science of physics’ and the question despite those successes then becomes: Why not?” Answer: The historical chronology of events were such that key physical concepts were developed in advance of crucial information science awareness and the vast bulk of humanity was seduced and fell prey to THE LANGER EPISTEMOLOGY ERROR also realized after those early foundations were laid. As a result, for the last 100+ years we have been operating inside a bubble of [only] ‘logically correct thinking’, both in terms of problems and their resolutions. Our successes, based on the logical correctness tied to the context of our collective thinking, has tightened the grip of the logic trap ensnaring our thinking. Resolution requires a multidisciplinary approach and capability to escape the logic trap otherwise ensnaring us. Holistically this patent accomplishes that objective. Resolution requires recognition of the larger tapestry created by Elegant Reasonism (e.g. this patent application).

### Reality

Elegant Reasonism recognizes reality in several ways or manners. {Real} reality spans all scales, distances, and is inclusive of everything real. This includes all {real} natural phenomena and real objects everywhere, without exception. {Real} reality is the same everywhere, it is isotropic. The preamble to Alan Turning's “Systems of Logic” presented a discussion of Göders theorem of incompleteness and observed that it also indicates a means whereby from a system L of logic a more complete system L′ may be obtained. Taken holistically Elegant Reasonism might be taken as a methodology to enact the improvements Turing envisioned. What Turning, Gödel, and many others to be sure, assumed is that the underlying interpretive model of the Universe (e.g. interpretive model of reality) is “capable” of perceiving ‘all that is’. When we observe that an assertion “cannot be proven”, we are in essence saying that that interpretive model cannot necessarily perceive an answer to that question. We hold as self-evident that belief systems whose basis are such incapable interpretive models which cannot answer such questions because “truth” is not derived from a unified reality. “At-scale” reality is that reality perceivable only at particular scales. Humans, for example, operate and otherwise exist “at-scale”, and as a consequence epistemologies so rooted are insufficient to form a basis for Elegant Reasonism. The ‘Principle of Locality’ and ‘Counter-Factual Definiteness’ are essentially manifestations of “at-scale” reality assumptions. What is required is an epistemology capable of integrating knowledge derived from {Real} reality based on ‘truth alignment’ with the context of the unified Universe, and that requires intrinsic ability to penetrate beyond human physiology's restricted ‘thresholds of perception’. The [real] Universe—is—unified.

### USPTO Patent Application Implications

Elegant Reasonism, whose truth is determined as a function of pluralistic investigations integrating a unified reality rather than simple contextual alignment with a model only logically correct, must be employed in order to assure the integrity of critical thinking necessary to comprehend this application. To do otherwise is to commit the Langer Epistemology Error. That first sentence means that the USPTO must employ the very patent being applied here in order to assess its value, otherwise the entire organization will fall prey to the logic trap that has ensnared humanity for over 100 years now. This particular patent application affects more than the entirety of the existing USPTO portfolio and future applications. It directly affects its own application, process, and trial. If the USPTO as an organization, does not come to grips with the implications of the Langer Epistemology Error, not only will this patent application fail, so to will humanity's attempts to achieve awareness of the reality of a unified universe. The Universe is unified regardless of our view of it. Failure to comprehend these issues enslaves humanity to the confines of a logic trap that is M1.

### ISO Standards

Elegant Reasonism demands rigor and discipline established by the International Organization for Standards (ISO) in quantifying and codifying abstractions employed in the various taxonomies. This especially includes, but is not limited to, ISO 9000 which is a family of Quality Management Systems (QMS) standards designed to help organizations (and groups) ensure that they meet the needs of their consumers and stakeholders while meeting statutory and regulatory requirements related to products and services—and in this case it must also conform to this patent as well as scientific principles and methods. Stakeholders and managers define investigation goals, objectives, and parameters including the level of detail required in order to meet those various criteria. All should be aware that standard QMS standards minimally delve five or more layers deep answering what may seem like standard questions. They are commonly referred to as “the five why's”. Quality metrics stereotypically integrate these processes into insight development. Herein they help sort out concept order, priority, and relations across systemic abstractions.

### Influence from Information Sciences

The body of work this patent application represents employs many concepts from Information Sciences, including but not limited to relational systems and relational databases (invented by E. F. Codd), Logic, Systems Engineering, Metrics (especially ISO 9000 QMS standards), Bayesian Statistics, and many others. Once it is realized that predominant thinking is a logical representation of a physical system the mind is liberated to pursue other descriptions using the technology being patented herein, most especially Translation Matrices. A derivative of our having employed these technologies was the development of The Emergence Model of Particle Physics. The act of employing Bayesian Statistics into Translation Matrices instantiates a means to integrate contextual belief systems manifesting in one interpretive model along a mode shifted dynamic into the contextual belief system which must be derived as a function of the underlying detail of the real unified Universe where we seek and (hopefully) find truth. The essential objective is “recognizing that truth”. The process of completing the Translation Matrices very often illuminates what must be in tacit, palpable terms. These types of analytical tools assists in the process of paradigm shifting and reconciling associated epistemological issues. Readers must remember that the Translation Matrices employed by Elegant Reasonism are employed across a plurality of encapsulated interpretive models representing more than one ‘universe’, rather a specific set of such models and that one of those must close to unification. In this way belief systems are illuminated across the range of paradigms of interest selected. This is one example of how Elegant Reasonism instantiates contextual mode shifting.

### Investigative Objectives and Goals

Elegant Reasonism is based on truth aligned with a unified reality. If the stakeholders of any investigation are not prepared to embrace such truth, they should not follow this methodology. Elegant Reasonism holds separate and distinct:
Unified reality as litmus (because we are intrinsically & inextricably part of it)
Interpretive Models of the Universe (both logical and physical)
Epistemologies, and the beliefs they produce (because believing is necessary but insufficient, especially if such beliefs are not Elegant Reasonism derived).
Entities, including humans and artificial intelligence systems

Critical thinking demands rigor and discipline which can sometimes be a hard, cold, and cruel master. No investigation should seek goals or objectives which the comprehensive set of encapsulated interpretive models cannot allow. That is one reason ‘unification’ must be sought as a priority in the development of any such model. Such questions are among the first that should be asked of any investigation. It is not a question of ‘belief’, nor of ‘faith’, nor ‘curiosity’, it is a matter of whether or not such models can manifest the idea or not. If they cannot, the construct is very likely not real, and ‘virtual’ (e.g. fantasy). If such goals and objectives are sought, then an entirely new encapsulated model which does support those metrics, the standards herein, and which can be shown through Elegant Reasonism to align with the established body of science and which closes to unification. That's a very tall order indeed. However, the option is open to pursue. Science has no mercy save the truth and herein that truth is aligned with the unified Universe. Elegant Reasonism produces a unified view of all that is across all scales enabling the use of smooth, discontinuous, geometric maps whose basis is a single geometric object (e.g. in the case of M5 an MBP or any configuration of them). Important here is derivation of truth associated with a unified view of reality. While other models may be successful their derivation of truth is different and that point should not be lost on anyone.

### Part Two (2): Illuminating the Path

Originally, circa 2005, when my investigation began which ultimately resulted in this application filing no one realized that what I was doing would result in the unification of physics (or anything else). Critical thinking; however, demanded realization that predominant thinking did not unify physics and that recognition required us to ask a series of “why not?” questions. Answering those questions required application of ISO 9000 QMS query techniques drilling many levels of depth across the spectrum of science and philosophy, both modern and historic. Wherever possible, original works were consulted. Not interpretations of original works, but the actual original source and its author in an attempt to assure what was meant by what was written. That same diligence and rigor is required of this patent process in every form and facet.

### Standards

As we consider any interpretive model, we must consider these factors relative to the various abstractions and their relative and respective relationship within that model. These relationships may span scale, architectures, concepts, constructs, and paradigms (and belief systems). Intrinsic to all interpretive models, the issue is the degree to which they are true and close. It would be a mistake to consider that these factors listed here are intended solely for the purposes of models regarding physics. They apply relatively and respectively to any set of investigative areas holistically considered by properly configured Translation Matrices. Indeed they apply to any investigation seeking truth in, from, and of, the unified Universe. Properly configured Translation Matrices are complex composite constructs (e.g. tools and technologies once completed) which must ultimately be considered holistically. Encapsulated interpretive models held within them are also holistic within their relative and respective boundaries. Composite collections of such technologies form bodies of Elegant Reasonism based work more powerful than any technology or tool this inventor is aware of in history. These factors applied in the context of such Translation Matrices can apply within a given model, but they can too span interpretive models of the Universe penetrating along dimensions associated with the paradigms of interest and simultaneously with associated sets of analytics. In this way these standards form a ‘fabric of integrity’ ultimately articulated in Treatise. Each of these various factors in this section may be considered as statistical factors in order to aid analysis or quality metrics of holistic Translation Matrices. Elegant Reasonism extends and solidifies the scientific method and its principles.

### Cells

‘Cells’ as a standard, refers to the content investigators place inside the intersection points between interpretive models and paradigms of interest at any given layer of Translation Matrices and it specifically demands Critical Thinking and Situational Awareness skills in order to properly quantify. The 2D Translation Table Articulation Layer tends to be ‘column centric’ as its general contents focus on manifestations of a specific interpretive model. In the case of the left most column those sets of cells are defined by the investigation. Other layers are similarly constrained by their relative and respective purpose and intent. Some cells have both horizontal components, others vertical, while still others have both horizontal and vertical requirements. For this reason it is imperative that proper knowledge management is applied to the development of these tools by investigators. Investigators are warned and cautioned that manifestations of a particular paradigm of interest remain true to the relative and respective interpretive model manifesting it. This requires such details to remain in context of the model. Knowledge management professionals should remain vigilant about various detail sets within a domain of discourse because constituents of such sets may change model to model as a function of mode shifted context relative to and respective of paradigms of interest. Paradigms of interest should ultimately be parsed as finely as required in order to completely quantify its manifestation across the plurality of interpretive models. M1, for example, must articulate how each of the dimensions ‘of space’ are made manifest relative to the factors required of the higher ordered construct of spacetime.

### Class

Remember that Translation Matrices have different Classes, or areas representing various domains of discourse. These various domains have their own requirements that are relatively obvious and need no specific treatment here because of that obviousness. What is not obvious are the requirements of encapsulation of interpretive models. Depending on how a given investigation defines its objectives and goals will drive the taxonomy associated with such class distinctions and the domains of discourse they represent. What is important is the rigor, diligence, critical thinking, and situational awareness with which the investigator instantiates holistic integrity assurance. Also, remember that Translation Matrices employed at foundational levels are there for a reason and that they are very likely highly systemic. Even if a given investigation is not obviously influenced by them, there are very likely real reasons to perform a systems review. If a given systems review is not fundamentally based on a unified reality the truth it may report is a function of an incomplete context. That is to say its truth is necessary but insufficient, at best. In a worst case it is highly misleading, and likely committing THE LANGER EPISTEMOLOGY ERROR.

### Close

Close herein refers to the ability of a given interpretive model to completely describe all aspects of the model with no further assistance. In the case of interpretive models of the Universe this means the models must close to unification of physics. This requires the abstractions employed collectively, holistically and logically describe the Universe in a manner consistent with this section of this document. An inability of any given model to accomplish closure constitutes a Six Sigma “sigma defect”. The degree to which it does not must then also be quantified, calculated and analyzed as a function of the investigation employing the particular Translation Matrix. Whether or not a particular model closes or not will significantly influence that model's ability to attain the remaining factors of this section. The only interpretive model of the Universe known to this inventor which “closes” is The Emergence Model's logical view: M5. M5 is therefore included in the Appendix. Another aspect of a “closed” model is the expectation that in conforming with this section, that it does not change in any substantial manner. While this at first might seem counter-intuitive to science and the scientific method which constantly integrate change into their foundations, it is simply a manifestation of a requirement to iterate model designations or sub-designations. The concept here is one derived from the software engineering industry and employs versions and release levels. Once M1.00.000 has been declared then that “model” will be locked in perpetuity. It can iterate at some level but it cannot be allowed to change. It may only, and exclusively, be superseded by subsequent iterations or a failure to use it substantially in any investigation.

### Cogent

That any case, or argument, be clear, logical, and convincing. A good cogent plan (e.g. method) for anything is compelling and strong. Powerful cases are potent, effective tools and methods. This patent is deemed ‘cogent’. CRITICAL THINKING demands we realize certain factors relative to applying this metric. “Logical Truth” is not the same necessarily as “Elegant Reasonism Truth”. For example, M1 is logically true, but it does not close to unification, nor will it ever, yet many people see it as ‘cogent’. M5 can be considered cogent because of the single paragraph included herein and it does close to unification. Elegant Reasonism then positions M5 as more cogent than M1 for these simple facts. Being {holistically} SITUATIONALLY AWARE when pursuing any investigation in the context of Chart 5 of the presentation deck (e.g. DRAWING submitted with this patent application) cannot be stressed enough when making such judgments.

### Coherent

ENCAPSULATED INTERPRETIVE MODEL ‘COHERENCE’ means that every facet of any and every model of existence should be logical, consistent and united relative to the its holistic whole. Each such model's relative and respective associated sets of abstractions should patently demonstrate affinity for one another. Concepts from the smallest scales should be coherent relative to those at the largest scales and vise versa. TRANSLATION MATRIX COHERENCE holds the same meaning except that it applies to the holistic Translation Matrix employed by the relative and respective investigation. The same standard holds relative to the subject of TREATISE COHERENCE. Here again Chart 5 in the submitted DRAWINGs should be consulted.

### Cohesive

Facets of ENCAPSULATED INTERPRETIVE MODELS should “flow” easily within characterizations and intuitively ‘fit’ relative to other facets of the relative and respective model. This is not just true within a given model relative and respective of the abstractions that model employs but from those abstractions out to the various paradigms of physics as well. Each facet should ‘stick together’ forming synergistic whole. These same characteristics should be evident in the relationships between a given encapsulated interpretive model and the neutral paradigms of interest being investigated. The same requirement exists between such manifestations and the analytics applied against it in the subsequent analytical layers. Conclusions in Treatise, depicted on Chart 5 in the DRAWINGS file should have the same cohesiveness to the body of work produced by the Elegant Reasonism based investigation producing it. Each constituent facet of any given model should dovetail with one another as a jigsaw puzzle pieces form an entire image once completed. Because Elegant Reasonism produces a ‘unified view’ in alignment with the unified Universe, disparate investigations may be very quickly related via “CONCEPT CONDUITS” (e.g. common constructs spanning investigations). An example linking Elegant Reasonism investigations into, say The Emergence Model, to say economics might use ‘action’ as a CONCEPT CONDUIT into the body of work completed by Ludwig von Mises in his Treatise on economics entitled “Human Action”. When we realize the linkages between human physiology, neural networks, and the epistemologies they produce we quickly see the relationships between The Emergence Model and ‘action’ spanning these various disciplines and at each step and stage the observations made and insights gained grow more powerful because of the unified view (e.g. coupled to the unified view of the unified Universe). We also become saliently aware of the importance that belief systems have basis in Elegant Reasonism. Such foundations are powerful beyond words to describe.

### Communicative

The holistic whole should represent a relevant story or contain a core message about which the narrative is built. Nothing in that story should be incongruent relative to the holistic whole and that holistic whole should be built on an interpretive model which closes to unification exactly because such models are foundational and systemic. That means those fundamental concepts are inter-related with all higher ordered concepts and should intrinsically support that holistic story. This systemic nature connects and provides communications threads from the most fundamental to the largest concepts conveyed. Generally the more a given investigation aligns with these STANDARDS the more communicative it will be.

### Language Usage

What is meant by this topic title is not English, French, German, Italian, Spanish, etc., rather it is construction of sentences consistent herein to mean what you say and say what you mean. A review of technical history will result in an illumination of ‘claims’ being made that may not have been intentional, but manifest because of lack of attention to language usage or critical thinking not being adequate to the task at hand. Knowledge assumptions play into these issues as well. Broad agreement to those assumptions is also a factor.

Language usage is so vital a factor it is important to understand that it too is affected by “MODE SWITCHING” from one model to another. It is vital to understand this because the answers to what, when, where, why, and how—change model to model. This fact is another reason supporting the creation of the phrase ‘mode switching’. An example of this is if we ask a question about acceleration ‘why’ in M1 might result in Newton's laws being cited. Not until we understand M5 do we realize that M5 is ‘why’ Newton's Laws are true do we realize that what Newton said is a description of ‘what’ happens—not ‘why’ it happens. Consequently these issues are not trivial and must be inspected with great vigilance, diligence and perseverance. However, these issues are not likely to be rendered explicitly clear absent properly configured Translation Matrices and full pursuit of a Treatise illustrating its basis through Elegant Reasonism.

Words like “system” take on a whole new meaning in the context of M5, for example, because therein everything is a system or ‘system of systems’. In that context words like ‘complete’ hold differences deeply systemic and different from what we might otherwise expect. Words used both by science and philosophies must also be reviewed to assure their relative and respective meanings do not change by interpretive models. Independent descriptions of investigations which accompany properly configured Translation Matrices should clearly identify the interpretive model to which it is associated. This can be done by placing the model and its reference number in parentheses prior to the beginning of the text. (M1), for example.

### Complete

Complete herein means that all aspects of the various models are included and reconciled. That requires a clear articulation of all that works, all that does not work and implications of outstanding issues for each discrete interpretive model included. What does not work must be included as a ‘Sigma Defect’. It is not permissible to ignore these inabilities in sigma calculations. Logic artifacts and incongruities too constitute sigma defects in logically correct models. As of this writing M5 is the only complete model. Interpretive models of the Universe should close to unification. They should describe the Universe “Big Bang” to “Big Bang” (e.g. from the beginning to the end and describe what happens at each stage. The interim phases should describe particle development comprehensively describe both inorganic and organic processes. The model should conform to the entire set of “the realm of the C's”. All physical properties should manifest as a function of the interpretive model as well as the fundamental forces of nature.

Completeness does not mean necessarily that 100% of all the details must be in every Translation Matrix employed by investigators. It does mean that in cases where multiple Translation Matrices are employed that they are clearly delineated, enumerated, labeled, and demonstrative of CONCEPT CONDUITS manifesting their relatedness. Such CONCEPT CONDUITS manifest ‘threads’ of relatedness manifesting the ‘tapestry of the unified view’ of a given encapsulated interpretive model and the Elegant Reasonism TREATISE it supports. Their relative and respective relationships across the entire set of such tools must be clearly established. In this way foundational details may be relegated to one tool and inherited traits spawned from it to others. In all cases however, the holistic sets of Translation Matrices must conform to these same standards across all scales.

### Concise

Requires that volumes of information be articulated with as few a words as is possible and in the clearest manner possible. Brief but comprehensive. Synonyms are succinct, pithy, incisive, and brief. The material should be short and to the point. An example is the body of work this patent application represents comprises almost 3,000 pages of material resulting from 15 years of R&D, and distilling all of that down into these few pages is an example of how to be ‘concise’. Given that everything in the Universe may be made manifest through The Emergence Model paragraph included herein also constitutes an example of conciseness.

### Conformance

Conformance here means the degree to which each element of an investigation adheres to the requirements of the various processes employed, QMS standards, etc., articulated herein (but not limited to or by those so articulated). ISO 9000, for example, has its own set of standards and those are subsumed by this patent. That is this patent integrates those standards here as well and expects investigators to conform to those standards as well as those articulated directly here. There are many standards simultaneously governing Elegant Reasonism. Investigation teams must determine how to balance these requirements against the stated objectives and goals of their particular investigation as required by stakeholders. This particular section, covering standards, must also integrate other standards like those imposed by ISO 9000 Quality Management System (QMS) of standards, those imposed by Bayesian Statistics in order to support that set of analytics, Logic Calculus, etc. Standards then must be holistically considered in context of whole Translation Matrices, especially the Treatise articulating subsequent insights based on these developed resources. Knowledge Management also imposes standards and requirements in order to maximize potential gains from an Elegant Reasonism based adventure. The standards provide a means for others to follow in the footsteps of an original investigation team and duplicate the Elegant Reasonism derived conclusions. The scientific method demands no less rigor; however, Elegant Reasonism imposes new disciplines in the form of the methods, processes and tools employed in order to develop insights. Historically traditional methods are useful, necessary, but too often prove to be insufficient specifically due to their epistemological derivation dependent on human physiological perceptions regarding evidence. A larger canvas is required and Elegant Reasonism rises to fill that niche.

### Congruent

Each interpretive model of the Universe requires that the relative and respective abstractions it employs to align with its own rules, regulation and definitions. This is also true of those abstractions as they may be employed as constituents of higher ordered constructs and paradigms. Congruence is both internal and external to all interpretive models of the Universe. The degree to which we have high internal congruence and imperfect external congruence implies the potential existence of ‘logic artifacts’ that model possesses relative to actual reality. The congruence of any given model is an important factor relative and respective to that model's integrity and its ability to align with affinity to reality.

### Consistent

Each and every abstraction, construct, paradigm, model, rule, regulation or other characterization employed within any given Translation Matrices be applied in the same manner relative and respective to that particular model as those factors relate to the various paradigms of nature or of interest. Consistency as it relates to Translation Matrices that analytics employed against one interpretive model of the Universe must be equally applied everywhere else in the particular Translation Matrix. Technologies related through CONCEPT CONDUITS must also demand consistency across the entire set of so linked tools forming the basis of technologies.

### Context

Here again a term has duplicitous meanings in so much as it applies to individual models as well as the holistic Translation Matrices employed and it applies to the various elements of the relative and respective models. We must remember that each interpretive model of the Universe employed by any given Translation Matrix establishes its own context. One implication of is that one cannot think about any given model in the context of a different model. This is not “a rule”, it is a reality observed. Encapsulated interpretive models of the Universe create their own context and any trial based solely on such an exclusive and narrowly defined manner is subject to that lens. It is for this reason that Elegant Reasonism requires a plurality of interpretive models to be employed and requires one of those models close to unification exactly because such encapsulations which do not close to unification can only be logical in nature. Furthermore, it is imperative that the USPTO considering this patent application—actually use this patent application as the basis for assessment of uniqueness. To do otherwise is to commit THE LANGER EPISTEMOLOGY ERROR. The USPTO must assess the uniqueness of this patent using Elegant Reasonism as a process within its own organization in order to find the actual real value it holds. The inventor stands ready to assist the USPTO in that endeavor. Any similarity of context across models is coincidence and should not necessarily be construed as ‘congruence’. One of the purposes of Translation Matrices is in translating or managing these various issues from model to model. Implications are that we must identify the basis interpretive model for any given description, at any scale, in order to establish the proper context for the language used in that characterization. Investigators are highly encouraged to use the standard nomenclature “(Mn)” where ‘n’ is an integer from 1 to 7 referencing one or more recognized interpretive models of the Universe prior to any given text. This predicate label will assure their readers of the intended context for the usage of chosen language characterizing their investigation. This is especially true of any treatise employing Translation Matrices. Parsing such treatise will undoubtedly require conversation and discussion about the various interpretive models employed and because those models require “mode shifts” in the thinking behind them such a label becomes imperative to assure effective communications between the authoring team and any reader.

Logically correct experiments, conducted in a logically correct manners, immersed in a logically correct interpretive model of the Universe will produce logically correct results; however, that has absolutely no bearing on whether or not any of that effort necessarily represents actual real physical reality. Such represents the ‘logical correctness’ relative to the ‘context’ of the underlying assumptions (e.g. detail).

Establishing the basic context of a given problem area against which problem determination and root cause analysis will be applied also incorporates an inventory of existing knowledge of the situation manifesting existing awareness. The cost of doing something may not be as great as the cost of not doing something. In this case, not employing Elegant Reasonism. Basic context presumes foundational constructs which are highly systemic and manifest perceptions through which the various team members engage reality at its various scales may be incongruent with actual {real} reality. If predominant thinking is mired and otherwise ensnared by a logic trap then that logic trap forms the perceptive lens through which everything is interpreted. That lens will only allow the team to perceive events and circumstances “as the lens permits”. If the lens ‘paints a certain picture’ then that picture is the only picture the team will see. Elegant Reasonism demands a plurality of interpretive lens, one of which must close to unification. Only when the Elegant Reasonism approach is properly engaged will the team realize that there are real objects, circumstances, phenomena, and events transpiring which other models (e.g. interpretive lenses) were not showing them at all. In effect, they are taking off their ‘rose colored glasses’.
Determine the set of foundational interpretive models required to illustrate the required plurality in order to illuminate needed insights.
Document contextual changes between the various interpretive models and isolate foundational paradigms of nature for integration into the processes herein.
Determine contextual layering by interpretative model. Such layering will establish systemic factors, relationships, constructs, and other aspects respective and relative to each interpretive model. For composite architectural systems also determine the various ‘orders of complexities’ in order to determine the number of lower ordered constructs involved which also may need to be understood in context of higher ordered systemic issues.
Inventory, by interpretive model, the various abstracts, constructs, paradigms, paradigm stacks and their relationships, rule sets and descriptions in order to articulate how the problem being investigated manifests through the lens of each interpretive model. This includes all elements of all mathematics, their parameters, tools and methods, constructs, axioms, etc. necessary to reflect each interpretive model's ‘point of view’.

### Critical Thinking

CRITICAL THINKING might be distilled down to “walking your talk”. It is more than that and requires systemic compliance with, but not limited to, the holistic set of STANDARDS articulated herein. It requires SITUATIONAL AWARENESS not just across the domain of discourse represented by Chart 5 in the DRAWINGS presentation deck, but throughout history as well. Critical Thinking requires honesty not just to an investigation but within each individual relative to their own internal belief systems and the paradigms manifesting them. Each individual must wrestle with their own paradigm shifts. Others cannot do that for them. Undergoing such a transformation requires critical thinking, incredible fortitude, and intrepidity.

### Truth

Elegant Reasonism truth fundamentally, and ultimately, lay in context of, and alignment with, the reality of the unified Universe. Just because we believe something does not necessarily make it true, despite our sometimes fervent belief to the contrary. Elegant Reasonism truth aligns with the standards outlined herein as a function of alignment with the unified Universe. “What” we ‘believe’ must have some basis in an encapsulated interpretive model in order to survive Elegant Reasonism treatment in TREATISE. That statement necessarily employs the use of encapsulated interpretive models in order to attain such an alignment because we never, ever, claim that we are directly describing the actual real reality exactly because we always hold it litmus in discerning truth. Contextual truth may manifest within any given encapsulated interpretive model but must meet STANDARDS based metrics. Such truth means that, to the extent possible, a model may find great congruence with the standards herein, but it does not close to unification. M1 is such an example. M5 also finds great congruence with these same standards and it does close to unification. Both M1 and M5 are simultaneously true to their respective logically correct views. M5 does close to unification and therefore, relative to Elegant Reasonism, holds a greater truth than does M1 for that reason. So long as an interpretive model manifests paradigms of interest in compliance with the standards herein it may be said to minimally be logically correct. At sometime in the future someone or some team may use Elegant Reasonism to develop a better model than M5. When and if they do it may have a greater truth than does M5, but until then M5 is the model we have “on the wagon”. We must realize ‘having truth’ does not necessarily imply that model rises to the level of ‘Elegant Reasonism truth’ unless it also closes to unification, simultaneously relative to and respective of the existing encapsulated interpretive models and real unified reality. Just because a large group ‘believes’ something does not make it true unless it can also be made manifest through Elegant Reasonism.

### Techniques

The specific techniques employ tools borrowed from the Information Technology industry, most especially the concept employed by Internet Protocol Servers called ‘translation tables’. Translation tables (in the IT industry) convert machine addresses (on the Internet) to human readable addresses. Translation tables then are distant ancestors of the modern Translation Matrices described herein. Where translation tables are two-dimensional, Translation Matrices are three. Explicit detail is provided in the patent application. Essentially the Translation Matrices takes a pluralistic approach to encapsulated interpretive models of the Universe (one of which is required to close to unification) applied against a neutral set of investigative ‘paradigms of nature’, subjects the holistic properly configured & completed Translation Matrices to intense analytical scrutiny, and holistically develops insights in formal or informal Treatise as is appropriate to the defined objective/goal. It should be noted that full “FORMAL” treatment must simultaneously comply with the STANDARDS and very likely the APPLICABLE UNITED STATES CODE appropriate for the submission of patents to the USPTO, including those regarding formatting material. This patent application is one example. Because one of the interpretive models so employed is required to close to unification, and because Elegant Reasonism seeks truth as a function of a unified reality, the holistic TREATISE resulting from these various techniques delivers unique and distinct methods leading to processes that are “self-clarifying”.

### Translation Matrices Layers

When the development of this material began circa 2004 simple ‘tables’ were used for “translations”. Over time, it became obvious that adding layers to the tables significantly improved the usefulness and power derived from these tools and methods thus transforming a 2D instrument into a 3D mechanism employing both vertical and horizontal components. As they matured they became vitally important in their own right separate and distinct from the investigations for which they were being used. There really is no officially correct set of layers. What is important is that there are enough to comprehensively meet the objectives of the investigation underway. Elements of each layer generally follow the columnar layout of the various interpretive models of the Universe employed. The rigor associated with any given layer is also a function of need associated with the particular investigation. Investigations happen to be costly and investigation teams accountable to national or global organizations then it might be conducive to be as complete and thorough as is humanly possible. Below is an example of the layering and rationales used in the development of this series (which ultimately led to the unification of physics):

TABLE 1
Translation Matrix Generalized Layering
2D Translation Table Articulation Layer
Historical Context & Original Source Review
Model Integrity Analysis Layer
Model to Model Relative to Paradigms of Interest/Nature
(e.g. Paradigms of {real} Reality) Analysis
Paradigms of Nature (e.g. Paradigms of {real} Reality) Statistical Layer
Logic Calculus Layer
Reality Alignment Validation and Statistical Layer
Bayesian Statistics Layer
Translation Matrix Analysis Layer
Heuristics Analysis/Statistics
ISO:9000—QMS Standards and Analysis
Metacognitive Analysis Layer
Six Sigma Layer(s)

Each intersecting cell within each subsequent layer allows for increased levels of insights to be developed. Holistically fully developed Translation Matrices offer powerful tools and methods to supporting R&D, insights, exploration, engineering, design, materials analysis, all spanning the various science disciplines. The Emergence Model was developed in this manner. The table above is an example drawn from the book in the series focused on general approaches to translation matrices.

### 2D Translation Table Articulation Layer

The purpose of the 2D articulation layer is simply to outline the investigative areas in context the pluralistic interpretive models (one of which is required to close to unification). If a simple approach to an investigation is all that is desired then this may be all that is needed or required to fulfill an objective. However, if one wishes to carry out a full formal treatment for the purposes of a full understanding, or academic ‘proof’, then it will likely be necessary to employ additional layering and analysis. Once the matrices are complete then we may back up from the matrix and write a treatise based on that holistic view of insight developments which result. Together, that treatise and the Translation Matrices on which it is based, and that body of work may then be referred to as an “Elegant Reasonism based conclusion”.

TABLE 2
2D Articulation Table Generalized Construct

| Paradigms of | Model 01 | Model 02 | Model 03 | Model 04 | Model 05 | Model 06 |
|---|---|---|---|---|---|---|
| Nature | (M1) | (M2) | (M3) | (M4) | (M5) | (M6) |
| Relationship | Child of | Child of | Parent of M1 | M5 | Child of | Parent of |
| | M3 | M3 | & M2. | emulating | M6 | M5 |
| | | | Potential | M1 or M2 | | |
| | | | Peer of M5 | | | |
| System View | Logical | Logical | Physical | Logical | Logical | Physical |
| Paradigm 001 (P1) | P1 in M1 | P1 in M2 | P1 in M3 | P1 in M4 | P1 in M5 | P1 in M6 |
| Paradigm 002 (P2) | P2 in M1 | P2 in M2 | P2 in M3 | P2 in M4 | P2 in M5 | P2 in M6 |
| Paradigm “n” (Pₙ) | P‘n’ in M1 | P‘n’ in M2 | P‘n’ in M3 | P‘n’ in M4 | P‘n’ in M5 | P‘n’ in M6 |

It should also be noted that the various paradigms of nature may be aggregated, at the convenience of the investigative team, into related areas that are in of themselves prioritized relative to the investigation being undertaken. Core constituents of interpretive models should receive priority treatment due to their foundational and systemic nature relative to higher ordered concepts. This means investigative teams should take especial care and vigilance to assure that their ‘paradigms of interest’ are supported by the core precepts, foundational precepts, to which all interpretive models must adhere in articulating the manifestation of real systems under the various standards outlined herein. The manifestation of, for example, P2, across the various interpretive models is a function of the ‘core constituents’ of each relative and respective interpretive model. M1 declares length, width, and height, are “functions of space”, whereas M5 declares them as functions of MBPs and configurations of them. Physical properties, in M5 are a function of the resulting configurations and interactions across permutations of such configurations. The point here is that each intersection of “paradigms of interest” and the relative and respective ‘interpretive model’ must be consistent with the basic definition of such models and the standards herein. Because circumstances where “the mathematics ‘work’” may be necessary but insufficient to make a claim if such a claim is made within an interpretive model which does not close to unification. Systems reviews often illustrate what, when, where, why, and how change across such models.

### Paradigms of Interest/Nature (Left Column: ‘Paradigm 001’, . . . )

Generally speaking “Paradigms of Nature” (e.g. left column of Table 3) are the natural constructs and concepts encountered in everyday existence by the physical sciences and which Elegant Reasonism requires precise descriptions of their manifestation across the plurality of interpretive models of the Universe. Paradigms of interest are those paradigms defined by an investigative team applied against the same plurality. The distinction and requirement is that these paradigms must be real in order to qualify. That is they cannot be simply some logical construct from the imagination. They must actually exist in some real form that can be proven using some epistemology, preferably this one. Real concepts known to M1 but not M5 are exemplary quests. That is to say each interpretive model of the Universe must declare a position, status, or manifestation within that model, including all dependent and independent relationships. These constructs are required to penetrate all interpretive models employed in all Translation Matrices, without exception. The scope of an investigation should focus on only the set of such paradigms required to complete the investigation. There is no need to include such paradigms that are not needed or related to the investigation. Systemically related constructs forming relative and respective foundational aspects should be included, as they may drive unanticipated insight development. Paradigms of nature may be (to one investigation) the set of physical properties and in another investigation a completely different set. The “Translating Models—General Approaches” book in this series discusses this in different detail.

Paradigms of Nature, within Translation Matrices, occupy the top matrix layer in the far left column, such that they may be positioned to penetrate all interpretive models of the Universe occupying subsequent columns of this layer. Moving deeper into the matrix from this top layer finds cells dedicated for analytical purpose of the relative and respective paradigm of nature. Paradigms of Nature should be described in a manner that they survive description, or manifestation, in the various interpretive models of the Universe which they must penetrate. Each interpretive model of the Universe is required to describe, in detail, how that paradigm manifests within its context, if it exists at all. If it does not exist then that relative and respective model is required to state explicitly that that particular paradigm does not exist in that model and is essentially irrelevant in that context.

### Ordering of Model Articulations

Generalized investigations may choose any order, no order in particular, alphabetical listing of how groupings of the articulations manifesting the various interpretive models of the Universe are listed, or they may choose to group such paradigms by their systemic relationship to the holistic whole. What matters is that at each step and stage each KNOWLEDGE QUANTA is uniquely identified, enumerated, and labeled such that it may be referenced in TREATISE. However, if one orders them by how fundamental the various paradigms are, then their relative and respective ‘systemic nature’ begins to become quite apparent. Such ordering tends to aid CRITICAL THINKING. Investigators may have to list out their set and then re-order them based on a priority of fundamentalness relative to the holistic point of view they are interested in. Small changes at a very fundamental layer ripple out through and often become quite amplified in the process at higher orders of relatedness. This is the affect of Euler's Beta Function and exemplifies the concept of ‘convergence’.

### Historical Context & Original Source Review

Elegant Reasonism employs critical thinking which demands full historical context and original source review on every element of all Translation Matrices employed in developing the insights of any Treatise. Very often during this ‘mini systems review’ the investigation teams will discover previous investigator's have already noted their insights but did not have the justification necessary and so the broader community rejected their ideas. The investigation team may find new criteria justifying that original research. Case in point is the term “Rapidity” for the velocity of light. The term was in common before 1930, however in light of Einstein's papers establishing M2 of 1905 and in 1915 it was dismissed as incongruent. Later as Alan Guth, et al, of MIT developed the Inflationary Theory in 1980, the term was further distanced from the broader community. The popularity and general success of M1 drove the term ‘rapidity’ into obscurity. However, when the body of work producing this patent was in its formative review stages relative to the spacetime-mass interface it became necessary to investigate the nature of space. Salient here was the discovery of the term ‘rapidity’ and its common historical context relative to the subsequent interpretations of it. I then asked if rapidity was evident in the body of work in predominant use in present day. Much to my surprise it was then discovered that particle accelerators around the world use that term in their equations to align the particle beams inside their devices. And they do not use other derivations of M1 nor M2 for that purpose. That set of circumstances was observed and labeled as “LOGIC ARTIFACTS” of those relative and respective models and holistically designated “SIGMA DEFECTS” of those models.

There are many such examples which emerged from original source review and recognition of the historical context in which they existed. These should not be viewed as “points in time” but rather along the gradient from original inspiration or inception up to the present time and in context of the various encapsulated interpretive models of the Universe. Such a review allows for the various inflection points of such gradients to become metrics which other statistical layers may consider. This is especially true of Bayesian analysis. These analyses will be the source of many “Ah Ha!” moments for the investigators. Many such moments will be tacit and palpable.

### Model Integrity Analysis Layer

Because interpretive models of the Universe (e.g. interpretive models of reality) each manifest their own context, and the details of such a model are described in the columns of this layer, we can observe that “model context” is ‘column centric’ in this tool. The implications of what that means are that 100% of a model must manifest in the cells of that column for that relative and respective model. Remember, ‘reality’, is always held as unique and distinct from anything in Translation Matrices. Reality is the litmus.

Generally speaking, the “model integrity analysis layer” is this ‘row layer’ of the Translation Matrix; however, from the point of view of each employed interpretive model it is vertical and centered on the column of the relative and respective model. It is important that all the model integrity investigations be at the same row layer depth because other subsequent analysis will depend on that information being contained in that location. This point is generally true for all layers.

As a rule, abstracts by definition isolate and insulate higher ordered ideas from lower ordered details. Every interpretive model of the Universe employs abstractions. Related or interdependent abstractions may form composites in the form of constructs and paradigms. Together with the ancillary descriptions and mathematics these are taken to holistically represent a given interpretive model. Because 100% of a given model is encapsulated in this way and because reality is held apart for litmus purposes we now have a basis for an objective analysis relative to the integrity of a given model relative to reality. If we arrogantly presume that what we are describing within a given model “is” reality, we cannot make that objective assessment.

The intent of this layer is to analyze each employed interpretive model internally leveraging this ‘column centric’ encapsulation of the model. There are many aspects of the model which can be perceived, conceived, justified, etc. in this manner. Model integrity checks, “cell to cell” but remaining true to the ‘column centric’ approach will illuminate the thinking employed by a given model. This work effort should not be viewed as isolated nor sequential. It should be taken as integrated and recursive. As investigators holistically work the Translation Matrix as a whole they will inevitably find aspects of the various models which were earlier overlooked. Care should be taken to assure the integrity of each model is preserved and it is the responsibility of this layer to patently demonstrate that integrity.

### ‘M2M’ Relative to Paradigms of Nature/Interest Analysis

Now that each model's integrity has been established we may drop down a row layer into discussions of “model to model” issues, and we may also compare any or all of the various employed models to the investigative paradigms (e.g. paradigms of physics or paradigms of interest or paradigms of nature as the case may be). We observe that rows representing these paradigms (e.g. paradigms being investigated {far left column in Table 2: 2D Articulation Table Generalized Construct on page 52}) penetrate the various interpretive models manifest something else besides the obvious internal to any given cell or model. They illuminate a “simultaneity of truth” model to model. That is to say that each properly completed cell patently demonstrates how that model manifests the relative and respective paradigms being investigated. The row then takes that thinking and illuminates the ‘simultaneity of truth’ emerging on a model to model basis. This will be a key factor for subsequent layers, analysis and descriptions, especially the treatise that follows.

### Paradigms of Nature Statistical Layer

The ‘paradigms of physics’, ‘paradigms under investigation’ (e.g. of interest), or ‘paradigms of nature’, is generally construed to be the left most vertical columnar layer defining the paradigms which must penetrate all interpretive models along horizontal rows in the relative and respective intersecting cells in as neutral a fashion as possible. That's not to say each paradigm ‘must’ be implemented or manifest in every interpretive model but every interpretive model must declare its position on that paradigm consistent with the holistic requirements herein and remain relatively and respectively true to that model's context. As we complete these various components of Translation Matrices we observe development of the fundamental mechanics enabled by this tool.

### Logic Calculus Layer

During a given investigation and during the development of given Translation Matrices some portions of the tool may be incomplete because of known unknowns. This next layers down has a tendency to surround known unknowns and illuminate “what must be” exactly because we can now apply logic calculus to the various cells already completed and do so in three dimensions (3D). The power of these investigative tools and methods cannot be overstated when used properly. Investigators should take care to document insights developed by this layer, stage and effort. Often the insights revealed here are beyond a given model, though much will be learned about the various models here, and those insights need to be captured for discussion in the subsequent treatise of holistic Translation Matrices used by the team. Never lose an opportunity to capture insights.

The logic calculus employed here takes advantage of model integrity, model alignment, model to model simultaneity, and other issues of integrity which manifest because of the rigor and discipline employed at each previous layer and stage across the spectrum of investigations outlined by Chart 5 in the presentation deck submitted in the DRAWING file with this application.

### Logic Artifacts

A logic artifact is a concept, potentially a set of interrelated concepts, in an interpretive model of the Universe which does not align with reality and in that context constitutes a ‘sigma defect’. As in many areas there are degrees of alignment. Logic artifacts may be only slightly out of alignment, but something just doesn't fit and nothing in the interpretive model will correct the situation. Invariably logic traps leave tell-tale clues as to their nature in the form of “logic artifacts”. Logic artifacts are the set of incongruous issues most often arising within logic traps. “Concept Compression” is a form of a logic artifact. A logic artifact may be thought of as an “inability of a logic system to reconcile.” They are something that “doesn't feel right”, “is but should not be”, “rationale requires explanation that defies belief”. The inability of M1 to employ a single geometric basis point is a direct example.

We inventory logic artifacts because very often they are pointers to underlying problems. If that problem is an individual abstraction somewhere in the model then there is a chance it can be corrected. However, if it is with the core, foundational abstractions, on which every other concept in the interpretive model depends—then we have a different sort of problem. And in such cases we must, “stop—think—then act”. Action in that event may require recognition that the model we are working with is [only] a logical system and a different logical view is necessitated. That was the case when the initial review of M1 was conducted and the result was M5. Others may find fault with M5 and make the same determination yielding an even better model; however, this patent anticipates that eventuality and creates the methods being patented with that in mind. Elegant Reasonism will remain the method of choice in that endeavor because of the plurality of approach penetrates to core issues and illuminates foundational, systemic constructs to a holistic whole and measures belief systems along the way consistent with traditional systems engineering processes, practices, methodologies and techniques. M5 positions everything real as a system or system of systems which carries with it a dependency on systems engineering skills and training.

### Reality Alignment Validation and Statistical Layer

Because ‘reality’ is always held as unique, distinct, and apart from anything in any Translation Matrix it is always available for juxtaposition and comparative analysis from all points of view—and that fact is vital to the overall purpose of these tools, and methods, the philosophy of Elegant Reasonism.

### Bayesian Statistics Layer

Bayesian statistics is a theory in the field of statistics in which the evidence about the true state of the world is expressed in terms of degrees of belief known as Bayesian Probabilities. Referring then to Chart 5 in the presentation deck submitted in the DRAWING file with this application it should be clear to skilled reviewers of the importance Bayesian approaches hold across that spectrum of activities. Being able to quantify such analysis within Translation Matrices is an important assurance step leveraged in TREATISE. Such an interpretation is only one of a number of interpretations of probability and there are other statistical techniques that are not based on ‘degrees of belief’. One of the key ideas in Bayesian statistics is that “probability is ordered opinion, and that inference from data is nothing other than the revision of such opinion in the light of relevant new information.” And that capability is vital to MODE SHIFTING and KNOWLEDGE MANAGEMENT.

The Bayesian statistics layer is vital to the investigation team both internally and externally. It should be noted that the team may find it necessary to construct more than one layer to accomplish its tasks and objectives. Because “belief systems” are probabilistic, many different demographic sets can be employed in order to review the implications of a given investigation which the final ‘treatise’ will need to address. This point cannot be trivialized nor its value understated. A juxtaposition of these conclusions in the holistic context of properly configured Translation Matrices can drive team perseverance and confidence to articulate subsequent treatment within the text of their investigation's treatise.

These analytical layers may investigate everything from whole models to the most trivial abstraction employed in any cell of the 2D articulation layers. Remember that interpretive models of the Universe are foundational and highly systemic. That means that abstractions at fundamental levels influence everything ‘downstream’ from that abstract concept. When we have a plurality of interpretive models with different details on such abstractions then it is necessary in order to assure the integrity of the investigation that the proper ISO 9002 documentation is also collecting data and information to support the Bayesian Statistics Layers.

We cannot overstate the value nor understate the caution needed relative to this analysis layer of Translation Matrices in pursuit of Elegant Reasonism based investigations. The rationale for how vital these analysis are cannot be better exemplified than through the fact that each and every interpretive model of the Universe (e.g. interpretive model of reality) creates its own context. Each represents a ‘contextual truth’; however, the ‘simultaneity of truth’ across the plurality of such models bring new levels of analytical insights. Holistically and in context herein these tools and methods allow us to penetrate obfuscating issues, tie them to particular interpretive models, and extrapolate what must be across the spectrum of activities exemplified on Chart 5 in the DRAWINGS file submitted with this application. We can then focus on the requirements necessary to articulate ‘what must be’ in context of the investigation. The Emergence Model was developed in exactly this fashion.

### Bayesian Probabilities

Critical herein, Bayesian Probabilities are an interpretation of the concept of probability, in which, instead of frequency or propensity of some phenomena, probability is interpreted as ‘reasonable expectation’ representing a state of knowledge or as quantification of a ‘personal belief’. Bayesian Probabilities are therefore well suited as a critical basis, methodology, practice and technique, when layered into properly configured Translation Matrices employed to investigate relevant subjects intended to conform to Elegant Reasonism criteria.

The Bayesian interpretation of probability can be seen as an extension of propositional logic that enables reasoning with hypothesis (i.e., the propositions whose truth or falsity is uncertain.) In the Bayesian view, a probability is assigned to a hypothesis, whereas under frequentist inference, a hypothesis is typically tested without being assigned a probability. Bayesian probability belongs to the category of evidential probabilities; to evaluate the probability of a hypothesis, the Bayesian probabilist specifies some prior probability, which is then updated to a posterior probability in the light of new, relevant data (evidence). The Bayesian interpretation provides a standard set of procedures and equations to perform this calculation.

### Bayesian & Statistical Inference

Bayesian inference is an approach to statistical inference that is distinct from frequentist inference. Great SITUATIONAL AWARENESS must also be exercised especially because ‘inference sets’ are dynamic across the plurality of encapsulated interpretive models developed across the activities exemplified on Chart 5 in the DRAWINGS file submitted with this application. That is to say because a statistical inference may be drawn, for example in M1, does not necessarily mean it may also be drawn in M2 or in M5. Only after full development of the technologies can such inferences be analyzed. It is specifically based on the use of Bayesian probability to summarize evidence. A decision-theoretic justification of the use of Bayesian inference (and hence of Bayesian probabilities) was given by Abraham Wald, who proved that every admissible statistical procedure is either a Bayesian procedure or a limit of Bayesian procedures.[3] Conversely, every Bayesian procedure is admissible.[4]

### Statistical Modeling

The formulation of statistical models using Bayesian statistics has the identifying feature of requiring the specification of prior distributions for any unknown parameters. Parameters of prior distributions may themselves have prior distributions, leading to Bayesian hierarchical modeling, or may be interrelated, leading to Bayesian networks.

Such analysis across the spectrum of Chart 5 activities is vital relative to a given interpretive model of the Universe's internal integrity, subsequent ‘model to model’ analysis, and any needed analysis relative to the respective ‘paradigms of interest’. The ultimate conclusions of which would then holistically be articulated in the TREATISE.

### Design of Experiments

The Bayesian design of experiments includes a concept called ‘influence of prior beliefs’. This approach uses sequential analysis techniques to include the outcome of earlier experiments in the design of the next experiment. This is achieved by updating ‘beliefs’ through the use of prior and posterior distribution. Such designs for experiments make good use of resources. The experiments conducted by CERN where investigators believe they are communicating with alternate realities is an example in desperate need of an Elegant Reasonism based investigation. Billions of Euros are being expended on such experiments intrinsically tied to M1 thinking and mired within its logic trap.

### Statistical Graphics

Statistical graphics includes methods for data exploration, for model validation. “Model” in this context can be taken as individual interpretive models of the Universe (e.g. interpretive models of ‘reality’) or the holistic Translation Matrices employed by an investigation. The details of such usage would need to be articulated in the treatise ultimately delivered as part of the results of the investigation. The use of certain modern computational techniques for Bayesian inference have led to the need for checks, often made in graphical form, on the validity of such computations expressing the required posterior distributions. Such checks herein may be tied to any cell or set of cells of a three-dimensional Translation Matrix.

### Causal Bayes Nets

A causal Bayesian network is a Bayesian network with explicit requirements that the relationships be causal. The additional semantics of the causal networks specify that if a node X is actively caused to be in a given state x (an action written as do(X=x)), then the probability density function changes to the one of the network obtained by cutting the links from the parents of X to X, and setting X to the caused value x. [5] By now it should be intuitively obvious to any reader comprehending the magnitude of this patent application that such calculations are highly dependent on particular encapsulated interpretive models and great SITUATIONAL AWARENESS must be exercised across the spectrum of activities outlined by Chart 5 in the presentation deck submitted in the DRAWINGS file with this application.

### Bayesian Learning

Bayesian reasoning provides a probabilistic approach to inference. It is based on the assumption that the quantities of interest are governed by probability distributions and that optimal decisions can be made by reasoning about these probabilities together with observed data. Elegant Reasonism brings to these discussions and considerations the pluralistic contexts of multiple interpretive models of the Universe juxtaposed against paradigms of nature (e.g. of investigation). It is important to, machine learning for example, because it provides a quantitative approach to weighing the evidence supporting alternative hypotheses. Bayesian reasoning provides the basis for learning algorithms that directly manipulate probabilities, as well as a framework for analyzing the operation of other algorithms that do not explicitly manipulate probabilities. Bayesian learning algorithms that calculate explicit probabilities for hypothesis are among the most practical approaches to certain types of learning problems. Bayesian methods provide useful perspective for understanding many learning algorithms that do not explicitly manipulate probabilities. [6] Applying Bayesian learning in an immersive Elegant Reasonism environment presents the opportunity to employ machine learning capable of mode shifting contexts relative to a unified reality (and other interpretive models of the Universe). Employed in such a manner Bayesian analysis can assist justifying key design choices in neural network learning algorithms from a frame of possible neural networks. One practical difficulty in applying Bayesian methods is that they typically require initial knowledge of many probabilities. They can offer important insights in the process of developing investigative Translation Matrices working to illuminate areas of models previously never contemplated.

### Translation Matrix Analysis Layer

The Translation Matrix Analysis Layer is responsible for analysis of the holistic tool in context of the investigation's objectives. This layer establishes the necessary elements subsequently needed for quality management and six sigma purposes. The results of this analysis among others can be six sigma defects within individual models, ‘known knowns’, ‘known unknowns’, and ‘unknown unknowns’ not just across the various domains of each individual interpretive model of the Universe but the various holistic Translation Matrices employed by the investigation. Details in these various domains very often are different for each interpretive model of the Universe. These details will provide the basis for enumerated sigma defects relative and respective to each interpretive model of the Universe (e.g. interpretive model of ‘reality’).

### Heuristics

A heuristic technique, or simply ‘a heuristic’, is any approach to problem solving, learning, or discovery that employs a practical method, not guaranteed to be optimal, perfect, logical, or rational, but instead sufficient for reaching an immediate goal. Generally speaking Elegant Reasonism heuristics must still conform to standards articulated herein to the degree required and appropriate for a given investigation minimally across the spectrum of activities outlined by Chart 5 in the presentation deck. The reader is again cautioned about SITUATIONAL AWARENESS and CRITICAL THINKING. The dynamics required of individually deployed and employed skills prior to full development and maturation of the resulting technology is challenging, tedious, and often quite daunting. However, the more versed individuals become with Elegant Reasonism, the easier it become to wield the process. I can speak to that from personal experience.

### Heuristics Analysis/Statistics

Heuristics establishes the traditional observations relative to and respective of investigations; however, fundamental—systemic contextual changes (e.g. MODE SHIFTING) throws a monkey wrench into those considerations exactly because it changes the underpinnings of belief systems and that must be reconciled through Elegant Reasonism. The heuristic analysis/statistical layer identifies, quantifies, and translates heuristics ‘model to model’ relative and respective to and of the paradigms of interest being investigated (e.g. it empowers and enables MODE SHIFTING relative to and respective of the employed heuristics). We cannot understate the need for CRITICAL THINKING and SITUATIONAL AWARENESS.

### Iso: 9000 (Family)—Quality Management Systems Standards

ISO 9002—Quality Management establishes the criteria for documenting processes used by science and industry. This layer of Translation Matrices is intended to specifically address these criterion. The sources of information should be annotated for every element employed {in formal investigations} within Translation Matrices. Complex assertions, like Elegant Reasonism based patent applications, will also need to comply with applicable United States Code regarding formatting, marking, enumeration, and labeling. Completion of this layer will significantly aid review processes and enable others to replicate the details of any given investigation and at least in theory, come to the same conclusions as the original team performing the initial investigation or experiment. These are likely necessary steps and tasks required for complying with grants and sponsored investigations.

### Metacognitive Analysis Layer

We come to the Metacognitive Analysis Layer(s) this deep in Translation Matrices for a number of reasons, the least of which is that elements from the plurality of interpretive models have, by this time, become well-established and should be evident to the investigative team. The investigative team will be the first to ‘experience’ the insights developed through the Elegant Reasonism philosophy (epistemology), but they are almost certainly not the last. What must be done then is to consider the impacts these insights will have to demographic populations beyond the core investigative team. Various demographic sets will inevitably be described through a “Conscience Competence Model” of Elegant Reasonism as an epistemology. Both the elements considered here and the conclusions reached (e.g. results) will find value in TREATISE as well as any programs based on the Elegant Reasonism insights often integrated through Instructional Systems Design (ISD) and Knowledge Management (KM) systems.

### Six Sigma Layer(s)

The term “Six Sigma” comes from statistics and is used in statistical quality control, which evaluates process capability. Used in industry, the maturity of a manufacturing process can be described by its sigma rating indicating its yield or the percentage of defect-free products it creates. A six sigma process is one in which 99.99966% of all opportunities to produce some feature of a part are statistically expected to be free of defects (3.4 defective features per million opportunities). Motorola filed for a trademark on Dec. 28, 1993 including terminology associated with statistical modeling of manufacturing and established an internal goal of “six sigma” for all of its manufacturing. Traditionally, continuous efforts to achieve stable and predictable process results, by reducing variation, are of vital importance to business success.

Six Sigma can be traced to efforts of business in the United States working to compete with a Japanese business approach called Kaizen. Kaizen is the Japanese word for “improvement”. In business, Kaizen refers to activities that continuously improve all functions and involve all employees. It also applies to processes that cross organizational boundaries and into the supply chain. It has been applied across industry, in psychotherapy, and in life-coaching. Epistemologically herein it is considered intrinsic to neural network encoding, consolidation processes and holistically to Elegant Reasonism. SITUATIONAL AWARENESS and CRITICAL THINKING requires recognition that the biological entity cannot turn off access to sensory input and must manage such input through states, buffers, and other processes of the central nervous system. The Japanese word kaizen means “change for better” and essentially that is exactly what the {human brain function of the} consolidation process seeks to accomplish based on the collected experiences an entity has obtained in life. Elegant Reasonism simply evokes an external framework to augment these internal processes of the mind and manifesting infrastructure. Elegant Reasonism, as a process, provides a framework and mechanism by which such improvements may take place across the spectrum of activities outlined on Chart 5 leading to the development of an Elegant Reasonism TREATISE.

### Six Sigma Tools & Templates

Elegant Reasonism brings an entirely new set of framework issues to Six Sigma Tools and Templates that deliver unprecedented capabilities. Elegant Reasonism takes historically powerful scientific interpretive models, immerses them in an analytical, highly pluralistic set of tools, and methods, subjects them to context analysis relative to paradigms of nature illuminating, perhaps demanding, paradigm shifts away from the mechanisms of logic traps ensnaring traditional modes of thought. These tools and methods do not just disintermediate old modes of thought, they illustrate why the old modes of thought cannot deliver the net new insights and prove why the new modes of thought are the ultimate answer. No other philosophy of knowledge can accomplish such analyses and insights. Combined with ISO 9002 techniques these insights are documented in a manner which civilization can then act.

### 5S

The 5S idea of Separate or Sort (Seiri), Straighten (Seiton), Shine (Seiso), Standardize (Seiketsu), and Sustain (shitsuke), in no particular order can be used to teach general concepts to groups and is often associated with Lean Six Sigma. These activities will play important roles and factors in the activities on the left-hand side of Chart 5 as investigative teams or individuals conduct SYSTEMS REVIEWS of interest to them.

### Affinity Diagrams

Basing a decision on limited data is certain to generate problems and that fact is recognized by professional business process re-engineering, systems engineers, and statisticians. Others, however, may find making a decision without any data a bad habit to break. “Point mentality”—responding immediately to data that seems to indicate a change but may be a reflection of natural variation—is even more endemic to daily decision-making. How can outcomes be evaluated when there are multiple options involved, including ones that no one has anticipated? The answer to that question is the Affinity Diagram.

Where AFFINITY DIAGRAMS become invaluable to Elegant Reasonism are areas when conducting the activities exemplified on Chart 5 moving from left to right on that chart will inevitably be some aspects of various phenomena, events, or interactions, which are not apparent to one encapsulated interpretive model but which are very intuitively obvious to another. AFFINITY DIAGRAMS can play important roles not only in investigations but in the development of curricula for Knowledge Management purposes after the SYSTEM REVIEW or investigation. “Maxwell's Demons” and other phenomena of thermodynamics come to mind as examples.

Affinity exercises, named for the way in which ideas tend to group themselves together, are valuable tools and methods when issues or problems seem complex or difficult to understand. An affinity diagram offers a way to organize output from brainstorming. They can sort out uncertain, disorganized or overwhelming observations about a process, and they inspire participation and support from others. Complex problems are rarely simple. When a comprehensive list of factors is established they are grouped in to related categories.
Assign someone to coordinate
Agree on a statement of “issue or problem” and often formed as a response to a carefully crafted question.
Brainstorm responses to the question posed or problem stated. Groups can use the Crawford slip method, where members write down ideas on slips of paper or Post-It-Notes (which can be grouped later).
Each response is then grouped by their affinity to one another.
Each affinity group is then labeled with a one or two word descriptor (e.g. abstraction).
Members then review what has been discussed and actions taken. This step often clarifies issues and opens further discussions.

Affinity diagrams are useful in organizing disparate information of any kind. Problems must be reduced to ‘core’ issues, factors or values. Genuine problems are often crying out for solution. Affinity exercises offer an opportunity to reflect on what is most important. Affinity diagrams are a flexible tool that can respond to these different needs.

### Analysis of Variance (Anova)

“Analysis of variance” (ANOVA) is a collection of statistical models and their associated estimation procedures (such as the “variation” among and between groups) used to analyze the differences among group means in a sample. ANOVA was developed by statistician and evolutionary biologist Ronald Fisher. An ANOVA is a guide for determining whether or not an event was most likely due to the random chance of natural variation. Or conversely, the same method provides guidance in saying with a 95% level of confidence that a certain factor (X) or factors (X, Y, and/or Z) were the more likely reason for the event.

Great care should be taken using these analysis techniques relative to the plurality of the encapsulated interpretive models and the various cells of the Translation Matrices employed, across the spectrum of activities exemplified on Chart 5, especially (but not limited to):
Historical Context & Original Source Review,
Model Integrity Analysis Layer,
Model To Model (M2M) Relative to Paradigms of Interest Analysis,
Paradigms of Interest Statistical Layer,
Logic Calculus Layer,
Reality Alignment Validation and Statistical Layer.

The reader is cautioned to remember that “confidence” is “contextually based”. That is to say that confidence to some point immersed in M1 thinking only shows alignment internally to M1. The same point would be true for M5. However, that same confidence derived from Elegant Reasonism is held to a higher standard and demonstrates grounded knowledge derived in no other way. Elegant Reasonism derived confidence represents the best thinking civilization can produce. More than that and exactly because Elegant Reasonism is not based on M5, but an open philosophy which expects not yet conceived interpretive models which may replace M5, this philosophy of knowledge, this epistemology is the best that civilization will ever have.

### Lean Six Sigma (LSS)

LSS is a methodology that relies on a collaborative team effort to improve performance by systematically removing waste and reducing variation. The first concept of Lean Six Sigma was created in 2001 by a book titled Leaning into Six Sigma: The Path to integration of Lean Enterprise and Six Sigma by Barbara Wheat, Chuck Mills and Mike Carnell. During the early 2000's Lean Six Sigma forked away from the traditional Six Sigma. “Lean” traditionally focuses on the elimination of the eight kinds of waste classified as:
1. defects,
2. over-production,
3. waiting,
4. non-utilized talent,
5. transportation,
6. inventory,
7. motion, and
8. extra-processing.

Six Sigma seeks to improve the quality of process outputs, Elegant Reasonism included, by identifying and removing the causes of defects (errors) and minimizing variability in (manufacturing and business) processes. Herein these process steps are generally associated with the activities exemplified on Chart 5. Synergistically, Lean aims to achieve continuous flow by tightening the linkages between process steps while Six Sigma focuses on reducing process variation (in all its forms) for the process steps thereby enabling a tightening of those linkages. Lean exposes sources of process variation and Six Sigma aims to reduce that variation enabling a virtuous cycle of iterative improvements towards the goal of continuous flow. Epistemologically, Elegant Reasonism follows these same objectives with ‘flow’ being analogous to the scientific method and cognition. Elegant Reasonism allows investigative teams to ‘get underneath’ the fundamental assumptions whose systemic nature is a function of ‘interpretive models’ and apply a plurality of such models in the determination of these eight areas. What one finds is that what we thought were defects may be opportunity when viewed from a different precipice. The forces driving motion shift. The underlying factors driving the other factors may be just as revealing.

### Six Thinking Hats

The ‘Six Thinking Hats’ is a simple, effective externally derived (from this patent) parallel thinking process that helps entities be more productive, focused, and mindfully involved.[7] In the context herein this process helps focus investigative activity across a variety of areas.
1. White Hat: calls for information known or needed. Neutral and objective focused on the facts, just the facts and figures.
2. Yellow Hat: symbolizes brightness and optimism. Sunny and positive points of view. Under this hat you explore the positives and probe for value and benefit.
3. Black Hat: is careful and cautious, judgment—the devil's advocate or why something may not work. Spot the difficulties and dangers; where things might go wrong. Probably the most powerful and useful of the ‘hats’ but a problem if overused.
4. Red Hat: signifies emotions, feelings, hunches, and intuition. When using this tat′ you can express emotions and feelings and share fears, likes, dislikes, loves, and hates.
5. Green Hat: focuses on creativity; the possibilities, alternatives, and new ideas. The green hat is associated with fertile growth, creativity, and new ideas. It is an opportunity to express new concepts and new perceptions.
6. Blue Hat: is used to manage the thinking process. Cool, the color of the sky, above everything else, overarching organization. It is the control mechanism that ensures the guidelines are being followed and observed.

### Sigma Defect Classes

Elegant Reasonism can employ several, potentially many more, levels or classes of Six Sigma in its statistical analysis. Remembering that encapsulated interpretive models of the Universe create their own context requires that six sigma associated within a given interpretation be considered unique (e.g. exclusive) to that particular interpretation. What that means is M1's six sigma value has nothing to do with M5's six sigma value, because each interpretive model establishes its own base line context. Elegant Reasonism segregates six sigma calculations by types or classes for the purpose of subsequent statistical analysis purposes. Another type or class employed by this philosophy of knowledge spans all models can be construed as being associated with the paradigms of nature penetrating all interpretive models of the Universe. Still other types or classes are associated with elements of the various analytical layers, some of which require both horizontal and vertical linkages. Parsing these calculations in this manner allows for granular, quantification, of elements resulting from each interpretative model's manifestation of the paradigms of nature being investigated. Each model will likely have a unique perspective and set of sigma defects. The very strong implication here is that the SIGMA DEFECT which matters most are those associated with the right-hand most activities exemplified on Chart 5, especially those associated with development of the TREATISE.

The two major groupings of six sigma calculations are associated with:
Individual Interpretive Models of the Universe
Holistic Translation Matrices (e.g. the pluralistic investigation)
   A potential third class deals with the analytics associated with Translation Matrices, but those are generally considered elemental constituents of the holistic view (e.g. larger canvas or bigger picture outlined by Chart 5). Only the holistic class of sigma defects can be taken to align with unified reality exactly because they represent the pluralistic treatise absent bias imposed by a particular model. That is to say the representation reflected has taken into consideration that pluralistic foundation and integrated the systemic results into its tapestry. These various six sigma calculations then are consolidated in the SIX SIGMA LAYERS relative and respective to the particular investigation employing Elegant Reasonism. Remember, Elegant Reasonism is more than a method and process, it is also an epistemology. Considering Elegant Reasonism as a process, then requires enumeration of interpretive models (one of which must close to unification), establishment of the paradigms of nature respective and relative to the investigation underway, the various analytical layers necessary to establish integrity, and the final treatise. Everyone should take especial note of these distinctions in sigma defect treatment as they deal with programs, projects, and endeavors requiring significant capital resources. Making the wrong calculation here may doom those efforts to vanity.

All work reporting six sigma or ‘sigma values’ which are entrenched in a single interpretive model of the Universe (e.g. interpretive model of reality) only serve to convey a value relative to the context of that particular interpretive model and not to actual reality. This observation is vital. The vast majority of work reported to the various national science foundations around the globe today are reported in exactly this fashion. Where this becomes of significant consternation is that the contexts to which they are tied do not close to unification. Nobel prizes are handed out based on these values, and they could not be more illusory. Globally trillions of monetary value is expended against efforts based on such criteria. Elegant Reasonism eliminates these issues by employing a plurality of interpretive models and requiring one of those models close to unification. Thus focusing financial resources and human capital.

### Visibility of Sigma Defects

Only when we immerse investigations in ER are the holistic set of “sigma defects” illuminated. Not until the various Translation Matrices employ at least one interpretive model of the Universe which closes to unification are the actual and holistic set of sigma defects apparent. Therein lay an intrinsic message about the priorities associated with development of these tools, and methods, the models they employ.′ Only then are the ‘real’ sigma values manifest. Investigators may require more than one layer in order to accomplish this analysis consistent with time tested quality metrics and methodologies.

Which interpretive model is used as a basis or foundation for systemic contemplations matters because absolutely everything else manifests as a function of it. When we select an interpretive model which does not close to unification and which represents a logic trap, sigma defects will exist which are not discernible to the investigative team. Only when Translation Matrices are employed, as employed holistically by this series, are the various interpretations juxtaposed in a manner illuminating relative and respective sigma defects.

### Determining the Root Cause—the 5 Why's

Asking “Why?” may be a favorite technique of children often driving parents nuts, herein it is considered almost as vital as knowing the context in which it is asked. Root Cause Analysis (RCA) is a method of problem solving used for
1 It should be noted that at the time Albert Einstein was developing his theories “unification” was not his priority. The predominant body of investigators in science were concerned with the constancy of light and the failure of the Michelson-Morley experiment. That is why M2 is structured as it is. That it did not answer all aspects of alignment relative to reality is why modern investigators developed M1. Because each interpretive model establishes its own context that model's logical nature is not apparent to any investigator. Therefore it is highly inaccurate to say “Einstein was wrong”. Einstein was not wrong, its just that he was ‘logically correct’ and his interpretive model, M2, does not close to unification, nor does its modern incarnation M1.
   identifying the root causes of faults or problems.

For example:
1. Why?—Why will the vehicle not start?—The battery is dead.
2. Why?—Why is the battery dead?—The alternator is not functioning.
3. Why?—Why is the alternator not functioning? The alternator belt has broken.
4. Why?—Why is the alternator belt broken? The alternator belt was well beyond its useful service life and not replaced.
5. Why?—Why was the alternator belt not replaced? The vehicle was not maintained according to the recommended service schedule.←Root cause.

The questioning for this example could be taken further to a sixth, seventh, or higher level, but the normal five iterations of asking why is generally sufficient to determine a root cause. The key here is to encourage trouble shooting to avoid assumptions, and logic traps. The objective is to trace the chain of causality in direct increments from the effect through any layers of abstraction to a root cause that still has some connection to the original problem. Key in this analysis is “abstract analysis” in Part 1: Recognition and to assure that context is established relative to scale and relative and respective of interpretive models. However it would be a mistake not to apply these techniques across the spectrum of activities exemplified on Chart 5.

Another example:
Not realizing the implications of abstractions humanity commits Error: Reference source not found,
Theoreticians scratch their heads pondering why predominant thinking does not (cannot) unify physics, wilder and more elaborate theories ensue consuming much time, energy, effort and resources oblivious to their being immersed in an epic logic trap,
The inventor recognized M1 as a logic trap in 2005 and is motivated to continue his work culminating in this application filing,
The inventor engaging targeted discussions involving the results of having used Elegant Reasonism (the methods and process being patented were never disclosed) experienced denial that modern physics is not working directly with real reality. Some simply refuse to believe they are working with an interpretive model of reality rather than actual reality. Almost no one so engaged recognizes that they have committed Error: Reference source not found. Empiricism is cited most often,
The decision is made to document exclusively the method, process, and tools, for submission as a method patent for utility by industry, enterprise, and government under license by SolREI, Inc., a Florida based corporation. The intent is to facilitate rapid effective engagement across civilization to leverage these insights in the development of insights and technologies based on them (e.g. derivative works).

Root cause determination identifies factors considered as a ‘root cause’ if removal thereof from the problem-fault sequence prevents the final undesirable outcome from recurring; whereas a causal factor is one that affects an event's outcome, but is not the root cause. Though removing a causal factor can benefit an outcome, it does not prevent its recurrence with certainty. Elegant Reasonism employs active root cause analysis in its practice, methods and processes. Results are pluralistic-ally integrated into final treatise.

The aforementioned sequence is disintermediated when we:
Realize the logical nature of M1,
Create tools, methods, and technology to investigate the implications of M1's logical nature,
Conduct a comprehensive systems review into M1's logical nature covering (minimally) the set of details which resulted in the realization of M5,
Realize that M5 intrinsically unifies physics exactly because unification was a priority in its inception,
Recognize the extreme power of the methods, tools, and technology used to manifest M5 and the implications of them relative to epistemology,

The root cause of the problem/fault/challenge in predominant thinking is not just THE LANGER EPISTEMOLOGY ERROR [1], but the failure to recognize the implications of “abstractions” employed in models of how we think about reality. The root cause of our thinking cannot be identified until we realize that each interpretive model of the Universe establishes its own context. Until we can “pull back” to see the larger canvas representing civilization's thinking on these matters can we recognize and realize the implications of ‘real’ sigma defects. Traditional six sigma calculations will fail each and every time exactly due to this issue and because that is true we must change our “5 why's approach” to an approach that requires 6; which includes “context”. During the prosecution of root cause determination we must ask if our rationale is a matter of convenience or if it aligns with Elegant Reasonism. One example used in the series is iron ore. If one travels to Birmingham, Ala. and then visits the statue of Vulcan atop Red Mountain, named for the iron ore seams under it, you will see descriptions for those iron seams. They will speak of the seams forming from “iron fixing bacteria” and they stop right there as if those bacteria produced the iron or the iron manifest from the Earth. It did not. The only place that iron could have been produced was in the heart of a supernova and it had to have crossed interstellar distances to get here. The question is “why” they ‘stop’, asking questions at the point of bacteria. The answer to that question is because pursuing it further defeats the localization paradigm of ‘here’. It requires a holistic comprehension of astrophysics which many people are simply not prepared to accommodate in their belief systems. I leave to others to characterize the motivations of various belief systems as here it is likely obvious to the casual reader and needs no further characterization.

### Adding “Context” to DMAIC

Traditionally the 5 Whys is a technique used during the Analyze Phase of the Six Sigma DMAIC (Define, Measure, Analyze, Improve, Control) methodology. DMAIC however, presumes one factor missing from this list is always assumed to be the same and it is not. That element missing from the traditional approaches is: Context. Across the spectrum of activities exemplified on Chart 5 these issues become of vital import. Context of interpretation flows from the most basic interpretations of the Universe all the way up through every other consideration undertaken by humanity and across civilization. That context cannot be presumed—it must be declared and quantified in and through Translation Matrices. Herein, the Analyze Phase of Six Sigma is: CDMAIC, not DMAIC, and that first “C” stands for “Context”, because the following definitions are established by it. Context, must be the first defining priority exactly because of its systemic implications. If you do not know the foundational and highly systemic context then your definitions are meaningless. Especially in the context of mode shifted thinking herein. As you read each of these phases or steps, know that they can be applied both externally and internally. Epistemologically each is an opportunity for reflection and realignment of contemplative thought. Each represents an opportunity to align the neural networks and areas of the mind to unified reality which in the end is the objective of Elegant Reasonism.

### Six Sigma Context

Rhetorically consider the value of a Six Sigma calculation based on an interpretive model whose intrinsic nature is that of a logic trap and which does not close to unification. As you ponder that then consider the implications associated with making decisions based on those conclusions. Think about the stakeholders investing in those conclusions. Elegant Reasonism employs a pluralistic approach demanding at least one model close to unification exactly because “Context” illuminates various ‘reasons’ relative to and respective of interpretive models which are ‘encapsulated context’ into account, quantifies them, and demands such encapsulation be a hard requirement of critical thinking exactly because they are foundational and systemic. They certainly are the basis for any traditional definition contained in the “Define” phase of a Six Sigma effort. Also, exactly because this step has been isotropically ignored by traditionalists is one sure way to fall into THE LANGER EPISTEMOLOGY ERROR. Awareness that logic traps created by such errors is vital to critical thinking. Additionally, absent these declarations, another “almost certainty” is that the declared “sigma defects” will align with the context of a given interpretive model of the Universe (which does not close to unification) rather than actual {Real} Reality, thus strengthening the grip any given logic trap has on your thinking. Great care and caution must be taken through abstraction analysis, rigor, and disciplined critical thinking to prevent that occurrence.

### Defining Goals and Objectives

Define the goals and deliverables, both internal and external. While the purpose of this step is to clearly articulate the [Business, Industry, Science, Philosophical] problem, goal, potential resources, project scope and high-level project time-line, each one of these factors is not just a function of context, it is a function of the holistic Elegant Reasonism analyses. This information is typically captured within project charter documentation, but must be examined and evaluated in context of Elegant Reasonism. Write down what is currently known: seek to clarify facts (in semantic context), set objectives and form teams who will define:
The problem
The customer(s)
   Voice of the Customer (VOC) and Critical to Quality (CTQs)—what are the critical process outputs?

### Voice of the Customer (VOC)

“Voice of the Customer” (VOC) is a market research technique that produces a detailed set of customer wants and needs, organized into a hierarchical structure, and then prioritized in terms of relative importance and satisfaction with current alternatives. Across the spectrum of Chart 5 activities focus is on the consumers of the ultimate TREATISE might be. Herein we also extrapolate these factors in the context of investigations, knowledge management, philosophy, and science. VOC studies typically consist of both qualitative and quantitative research steps. They are generally conducted at the start of any new process, service, or design initiative in order to better understand the customer's wants and needs, and as the key input for new definitions, Quality Function Deployment (QFD), and the setting of detailed design specifications. Similarly, Voice of Business (VOB) is the requirements of needs, desires and inclinations, both spoken and implicit, of those who participate in any business as shareholders, or officers. This includes sources of information and metrics for performance measurement in context of Elegant Reasonism analysis. This information can be utilized to ensure business growth, and may be extracted from: Monetary & Market Information Examination, Competition Investigation, Worker Studies, Surveys, Opinion Polls, News Reviews. Metrics for VOB include ROI, Income Percentage from returning customers, and Shareholder Equity. Elegant Reasonism takes into consideration here the “perception point of view” expressed by ‘the customer’. The reader should be aware that Elegant Reasonism does not use this term exclusively in a ‘business setting’. Rather it is an epistemological context, inclusive of but not exclusive to, business. This broadened view integrates these techniques into the Systems Engineering processes and practices as a means to establish the framework holistically discussed herein in order to determine paradigm impact, insight development and Treatise articulation. Holistically then ‘customer’ is the epistemological consumer of the insights developed by Elegant Reasonism. The VOC & VOB implications of this type of customer, today, almost certainly implies the associated paradigm shifts which will almost certainly be encountered. When we consider value derivation in context of Elegant Reasonism there are implications that will deeply influence business epistemology globally.

### Critical to Quality (CTQs)

Critical To Quality is an attribute of a part, assembly, sub-assembly, product, or process that is literally critical to quality or more precisely, has a direct and significant impact on its actual or perceived quality. Epistemologically herein CTQs refer to the quality associated with application of Elegant Reasonism. This statement refers not just to a particular investigation, but the philosophy itself and application of it to any philosophy, science, individual, enterprise, institution, or agency. This includes, but is not limited to:
Business Processes (inclusive of knowledge management)
CTQ trees
Design for Six Sigma
Total Quality Management (TQM)
Total Productive Maintenance (TPM)

CTQ trees are similar to fishbone root cause analyses but applied in context of impact to ‘critical to quality’ issues. TQM consists of organization-wide efforts to “install and make permanent a climate where entities continuously improve their ability to provide on-demand Elegant Reasonism based value. Organization in this context refers to any group of entities, biological or otherwise. “Total” emphasizes comprehensive obligation to improve operations and cognition. “Management” emphasizes that ‘top-down’ activities manage Elegant Reasonism quality through funding, training, staffing, and goal setting. All traditional approaches to quality may be engaged through these processes in order to assure the integrity of the Elegant Reasonism Treatise associated with the particular organization or needs. TQM is a system of maintaining and improving the integrity of production and quality systems through machines, equipment, processes, and participants, stakeholders which add value to the relative and respective organization, business or otherwise. TPM focuses on avoiding delays, breakdowns, in associated processes and seeks to maximize ‘up-time’ and availability.

### Measure

The purpose of this step is to objectively establish current baselines as the basis for improvement and almost certainly requires a comprehensive analysis of “context” in order to determine the applicable and appropriate metrics for measurement derivation as a function of activities exemplified on Chart 5. This is a data collection step, the purpose of which is to establish process performance baselines. The performance metric baseline(s) from the ‘Measure’ phase of any investigation are to be compared to the performance metric at the conclusion of the investigation to determine objectively whether significant improvement has been made. Determination of what should be measured and how to measure it are of primary concern to investigators and drive associated decisions. This phase stereotypically requires much effort in assessing suitability of proposed measurement systems. Good data (spanning the field of contextual investigation) is at the holistic heart of Elegant Reasonism.

### Analyze

Epistemologically the purpose of this step is to identify, validate and select root cause for elimination. Investigators must quantify, codify, and declare 100% of the abstractions manifesting encapsulated interpretive models of the Universe which are then enumerated for iteration. Once declared models are iterated, not changed. This necessarily requires establishment of the associated Translation Matrices employed in support of the ultimate Treatise. The critical observation here is an ability to penetrate interpretive models from the point of view of the various paradigms of nature (of the investigation) which define the area of investigation. The objective is to articulate the paradigms of nature (of the investigation) from the relative and respective points of view of the various interpretive models employed by Elegant Reasonism. A large number of potential root causes (process inputs, X) of the project investigation are identified via root cause analysis. The top 3-4 potential root causes are selected as appropriate for further validation. A data collection plan is created and data are collected to establish the relative contribution of each root causes to the investigation metric, Y. This process is repeated until “valid” root causes can be identified. Within Six Sigma, often complex analysis tools and methods are used. However, it is acceptable to use basic tools if these are appropriate.
List and prioritize potential causes of problems (incongruent issues)
Prioritize root causes (key process/system inputs) to pursue in the improve step. The reader is cautioned here to pay special attention to the fact that M5 considers everything real, “a system”. The observation of that fact can have far-reaching and deeply-ranging implications to the investigation and the team pursuing it.
Identify how the process inputs (Xs) affect the process outputs (Ys). Data are analyzed to understand the magnitude of contribution to each root cause, X, to the investigation metric, Y. Statistical tests using p-values accompanied by Histograms, Pareto Charts, and Line Plots are often used to articulate the various issues, points, insights, inflections, etc., made by the investigative team.
Detailed process maps can be created to help pin-point where in the process the root causes reside, and what might be contributing to the occurrences.

While these steps and issues are typical in industry, herein they carry unique weight when immersed in Elegant Reasonism and any investigation so immersed. Elegant Reasonism provides and powerful net new context driving not just the analysis but the insights so derived. The associated investigators should be prepared to encounter sets of paradigm shifts never fathomed, both occurring in real time and needed beyond the sphere of the investigation. Such insights will need to be dealt with in TREATISE.

### Improve

The purpose of this phase/step is to identify, test and implement a solution or result of the investigation in part or whole. This depends on the situation, circumstances and holistic context. Identify creative solutions to eliminate key root causes in order to correct thinking. Brainstorming techniques are strongly encouraged, where Six Thinking Hats is just one example of such. This step can identify solutions that are not implemented, but simply noted.
Create
Focus on simplest and easiest
Test (Plan, Do, Check, then Act)
Based on results anticipate avoidable risks associated with any noted “improvement”
Create a detailed implementation plan
Deploy improvements

### Control

The intent of this phase/step is to sustain gains. Monitor, via metrics, to ensure and assure continued, sustainable success. Create a plan and update information as required and appropriate.

### Methods

Elegant Reasonism then employs properly configured Translation Matrices established in a manner that organizes the paradigms of nature, paradigms of interest, by fundamental systemic priority order. That is to say those paradigms most fundamental are grouped first and must therefore be answered first by each of the various interpretive models employed. This method requires each interpretive model declare, consistent with ISO 9000 QMS standards, exactly how each particular paradigm of nature manifests relative to, and respective of, that particular interpretive model. Keeping in mind that each interpretive model of the Universe is completely encapsulated and is required to establish its own respective and relative ‘context’. Contexts are not shared across interpretive models, hence the requirement to consider each as ‘encapsulated’. The original mandate set of ‘paradigms of nature’ of interest may be physical properties, phenomena, or behaviors observed in experiment. The set finally investigated is likely very much larger as it is required to include ‘linkage’ all the way back to the most fundamental core constituents forming each interpretive model of the Universe consistent with QMS standards of ISO 9000. For example: Steel, Alloys, Elements, Atoms, Subatomic Particles, and finally exactly, with precision, how those particles manifest from the core constituents of each of the relative and respective interpretive models. Focusing then on the most fundamental criteria for any given interpretive model we see that we must describe with precision exactly how each manifests that particular paradigm of nature. This is where we begin to see problems appear in the traditional approaches, and we do exactly because they cannot answer these questions with ISO 9000 QMS precision or detail. However, when we realize that predominant thinking is a “logically correct” model, we are essentially released from this requirement, but we are forced (e.g. hard requirement) to document that this particular model fails to articulate that manifestation to the degree required. For example, we traditionally speak of “objects occupying the three dimensions of space”. Yes we can measure those axis of any given object but are they “of the object” or are they “of space”. We can take this discussion all the way down to the most fundamental particle known to science, and we run into a road block at the core constructs of the interpretive model of the Universe employed by predominant thinking (which this body of work refers to as M1). The core constituents are: Mass, Energy, and Space. Einstein's equation E=me is the mass-energy conversion equation. The problem is that there is a spacetime-mass interface across which no space, nor mass, may cross without first becoming energy. This is why we cannot use a single geometric basis point in any traditional reference frame to describe all objects in that frame. Being able to use such a common geometric basis point is a fundamental requirement of unification (of physics). However it is also why we cannot explain how one dimensional objects become two-dimensional become three-dimensional objects. That process is fundamentally absent from M1. Again, we must ask “why?”, and the answer will astound you. The answer is that what Einstein developed all those years ago is in fact a logically correct description of a physical system. It is a logical view of a physical system that happens to be different, but supports the logical view. When we enumerate M1 comprehensively we have known for decades it does not unify physics, but what becomes glaringly apparent here is that it never will. And that prompts the question “what will?”. That point in context herein led directly to the development of The Emergence Model of Particle Physics using this method in an investigative process holistically consistent with this patent. The preceding text uses real examples to illustrate the method of detailing a given interpretive model of the Universe's ability to manifest a paradigm of nature. In this case M1's ability to manifest each of the fundamental dimensions “of space”—in—a given object, at any and every scale.

### “Mode Shifting” Model to Model

The actual act of switching or shifting from one model to another using Translation Matrices or Translation Tables is simple and easy—once they are created and understood. Specifically due to the uniqueness of each respective and relative encapsulated interpretive model of the Universe establishing different relationship patterns, such ‘switching’ is referred to as “mode shifting” to preserve changes in perceptions of context.

CAUTION: It is generally not possible to consider a facet of one model in the context of a different interpretive model of the Universe. Considerations must be translated and accomplished via effective translation and analysis offered by the various Translation Matrices used to accomplish a given investigation. Detail required is a function of complexities being investigated. Investigations must allow for appropriate detail.

Because models represent ‘encapsulated contexts’ unique in which the various paradigms are manifest—switching between models for investigative purposes requires the use of Translation Matrices discussed herein. At issue is that a paradigm of interest very likely manifests different touch points within each relative and respective interpretive model employed and for that reason those touch points must be fully comprehended in context through situational awareness and critical thinking. There are simply too many parameters and considerations to maintain properly in any other manner. Elegant Reasonism refers to this process as ‘mode shifting’, or ‘mode switching’ and is the process of documenting and articulating such touch points relative to paradigms of interest across a plurality of interpretive models of the Universe, one of which is required to close to unification. Mode shifting or mode switching, is an easy way to refer to differences between how various models manifest paradigms of interest and to remind us all that switching between models is not easily accomplished absent such tools and methods (hence this patent). The word ‘mode’ is used exactly because absolutely everything changes from one model to the next. What changes is not {Real} reality, rather how humans think about it. Just one facet doesn't change—they all change. The change is radical. The change in point of view is revolutionary not evolutionary. Knowing what ‘mode’ a given conversation is in, whether that conversation is written or spoken, allows people to establish ‘context’ at the beginning of a paragraph, paper or even sentence to sentence if need be. Which mode comments are based is vital to communications. Readers or participants can then easily refer to a Translation Matrix or Translation Table in order to gain deeper context of the statement. How important this is cannot be understated. Out of context statements to the uninitiated will sound like gibberish. Participants should be versed in these tools, and methods, so they may understand the basis or genesis of the comments being made they may as well be a seahorse looking at a wrist watch. Nothing they hear will make any sense to them. To the extent possible it is advisable to provide participants with the base Translation Matrices or Translation Tables, so they have a handy reference detailing contextual changes model to model. Logical and statistical layers being provided will increase the integrity of the model and make teams engaging these areas of interest all the more effective.

### Part Three (3): Holistic Analysis

Looking then at Chart 5, we see that Parts 1, 2, and 3 are not necessarily concrete delineation points in the method or its processes. It is simply a manner in which to articulate the predominant actions taken by investigators.

### Processes

What the process accomplishes is the proper configuring of Translation Matrices in Part 2, complete to the degree necessary to support the objectives and goals of a given investigation, and will in all probability yield direct insights based on Elegant Reasonism ‘truth’ articulated as a function of a unified view of reality for incorporation into subsequent Treatise. The resulting Treatise developed holistically is one of the most powerful tools in science today. The process using these tools may recursively review each step and stage as a function of insight development with increasing refinement at each subsequent pass. Holistically, the Treatise, its documentation, properly configured and completed tools will demonstratively illustrate truth aligned with a unified reality. “Ah Ha!” moments should be captured at each step and stage for subsequent appropriate treatment in the final Treatise. There are various disciplines in science and industry holistically employed herein which each have their own externally defined processes: ISO 9000 QMS, Systems Engineering, Scientific Method, Logic Calculus, Bayesian Statistics, etc., and because they are externally defined need no description here. Each has a dedicated area within the holistic Translation Matrices. We simply employ those methodologies in a combined manner resulting in a unique approach to develop the insights this process produces. In the case of the original investigation undertaken which yields this patent application the process resulted in the creation of the first interpretive model of the Universe ever to close to unification: The Emergence Model of Particle Physics. As an epistemological process we must determine where truth lay relative to the objectives and goals of an investigation. Does it lay in the domain of a unified reality or does it lay in the domain of existing predominant thinking which does not unify physics? If they lay in the latter, much work needs to be done back in Part 2 and maybe in Part 1. The process requires a great deal of ‘backing up and re-calibrating’ in order to complete properly configured Translation Matrices consistent with the standards herein. Realizing the implications of abstractions as they are defined across the various interpretive models very often also requires considerable paradigm shifts. Wrestling with these is not easy and neither is comprehending the systemic nature of foundational constructs, but it must be done. When ‘unification’ is considered as a predicate priority of any given model it changes the dynamic of contemplative cognition.

“We cannot solve problems using the same thinking we used when we created them.”˜Albert Einstein

Einstein did not hold ‘unification’ as a predicate priority during the development of relativity. He was working on a different problem, namely issues relative to the speed of light. That history pertinent as it may be is not relative to the point nor is the success engendered by it. They are not relevant exactly because they are ‘logically correct’ in the context imagined by M1 thinking. What is relevant is that M1 is ‘logically correct’, because that ‘liberates the mind’ in order to consider other also logically correct interpretive models. In this case, the development of M5, which then spawned M4, etc. From a process point of view, the requirement to include a plurality of interpretive models and require that at a minimum, one must close to unification, creates a condition where what does not work is juxtaposed against what does and how it works is very likely to surprise the most ardent skeptic. ‘What must be’ is illuminated with such force and momentum as to assuage fears and drive confidence levels. This is especially true when one realizes that ‘sigma defects’ in one model are reconciled by different models. What matters is whether those defects align with a unified view of reality and not whether they ‘only’ align with the context of a given ‘logically correct’ model. Models must meet the standards herein to the degree possible and eliminate such sigma defects. When we step back from the science of physics, and view Elegant Reasonism as an epistemology whose truth is a function of a unified reality we gain many insights into many other areas of existence and contemplative thoughts. Most of which are beyond the scope of defining this process or patent. However, this patent absolutely will allow investigators to pursue such considerations and objectives.

### Elegant Reasonism, a New Epistemology

On realization of the limitations of human physiology and that traditional epistemologies were ultimately based on that physiological system it became apparent that a new epistemology, Elegant Reasonism, was required in order to integrate every condition across the spectrum represented by the actual real universe. Elegant Reasonism, as an epistemology, seeks truth aligned through an alignment with the unified Universe, and then bases its evidence against that litmus. This epistemological approach becomes even more powerful when we realize the linkages between The Emergence Model of Particle Physics across the entire spectrum of science and orders of complexities produced, both inorganic and organic. These insights are magnified on realizing the implication of an individual MBP being viewed as a ‘system’, implies every configuration of them is either a system or a ‘system of systems’. Maybe in hindsight something this powerful should do no less, nevertheless it was completely unanticipated. That we can relate particle physics to human action is also amazing to this humble inventor. When we realize that the Elegant Reasonism based paradigms we create manifest neural networks in human physiology our situational awareness within the realm in which we exist becomes much more salient and keen. Our progeny embracing Elegant Reasonism will wield powerful insights.

### Knowledge Management

Holistically, if the investigation team has pursued a comprehensive application of Elegant Reasonism to its fullest extents, they have gained the precipice necessary not only to leverage the insights gained, but an overview of the knowledge management landscape with which they must now cope with. Because the Bayesian layers will have called out the various associated belief systems involved, the placement of those systems within the body of investigative work will provide a roadmap for educators to bring those demographic sets toward the Elegant Reasonism based conclusions and the reasons such moves are necessary and required. This is yet another example of how Elegant Reasonism is ‘self-clarifying’. Investigators may want to develop a variety of Treatise which target different stakeholders for different purposes. Some are interested in the primary insights sought, while others are interested in the implications of having developed those insights, educators for example, and industry for another.

Implications of this Patent

The implications of this patent affect every human endeavor across civilization without exception. Elegant Reasonism, as an epistemology, is poised to dominate both philosophy and science disciplines. Each science discipline is affected in different ways but the roots of each integrate with relative ease, due to the systemic nature of core concepts that are foundational and whose nature spans orders of complexities and scales. When we seek truth relative to alignment with a Universe that is unified, (whether we like it or not), myth, mysticism, and confusion are eliminated of their own inabilities to manifest real objects and systems consistent with standards. Subsequent Elegant Reasonism based Treatise easily dove tail with the body of work represented herein. This intrinsic feature of Elegant Reasonism adds considerable credence to the validity and integrity holistically represented. A recent example is simple recognition of “systems linkage” between the fundamental definitions herein and the body of work by Ludwig von Mises on economics via the M5 action principle.[2] There is a direct correlation between these bodies of work representing a high affinity of alignment. It should be obvious that it is impossible to state 100% of the implications of this patent, since it touches all human endeavors without exception. Opportunities range from supporting various ISO requirements & teams, Quantum Computing, supporting systems reviews worldwide, to exotic R&D, and all need licensing under this patent.

### The Emergence Model of Particle Physics

The process defined herein requires the parsing of ‘interpretive models’ into to different ‘views’ consistent with Systems Engineering principles; one logical and the other physical. The reader is cautioned not to presume or assume that physical views are the actual concrete real objects encountered in existence. Remember, real reality is always held as uniquely distinct and apart from any description of it. Readers are also extremely encouraged to be conscious of the Langer Epistemology Error regarding any ‘view’ either logical or physical. Readers are further warned that logically correct descriptions do not necessarily mean they are describing actual reality, even if there is superficial alignment with what we perceive “at scale” congruence ‘aligns’. This is a simplistic description of the failure of empiricism. Generally speaking logical views are more precise than physical views if only because there is more than one physical manner to accomplish a logical goal. Remember, something may be logically correct, yet remain physically different. Hence the parsing of models into both logical and physical views. Here we use the example of M5 to conform to and comply with the patent's requirement to employ an interpretive model which closes to unification, because M5 closes. The official simple description of M5 states in paragraph 0144:

The Emergence Model's logical view (M5) logically draws its basis from Most Basic Particles (MBPs). MBPs are the quintessential integer and it is through their “intrinsic nature” all other concepts are derived. It is the MBP in M5 which manifests the three dimensions associated with all real objects, not space. M5 is centrally characterized by two processes so derived; “The Fundamental Entanglement Function” which is limited by the other, Severance. The Fundamental Entanglement Function, the ‘build’ process, entangles MBPs into all configurations of “architectural mass” generally envisioned to follow Knot Theory, including dark matter within any given Event Frame. Severance, as an independent process is ‘the failure mode’ of any given configuration of MBPs and represents the limits of architectural mass to remain intact specifically due to the intrinsic nature of constituent MBPs. Space, in M5, is dimensionless nothing. Force, all force, is the work instantiated through the Intrinsic Action of configurations of MBPs forming architectural mass. Architecture of relative and respective constructs so configured determines physical properties which manifest. Time is an “action displacement index” of the relative and respective architectural masses in the frame. Energy is the ability of relative and relevant architectural mass to do that work.

Paragraph 144 is a simple, single, paragraph that closes to unification in as much as it positions all phenomena as a function of the architecture formed by configurations of MBPs, their nature, and the rule set associated with them. The entire Universe may be described using this single simple paragraph so derived. The traditional discussions and experiments are functions of the basic processes associated with this same description. No mathematical equations are needed. No other interpretive model is able to write such a paragraph. Never in history has such a description ever been offered. From 2012 to the present day no experiment has broken this model, and that includes LIGO, and the recent first imaging of a black hole, the Hubble Ultra Deep Field imaging efforts, numerous experiments from CERN, and many others. When we fully comprehend the implications of this simple paragraph we can unify the various disciplines of science. We can also link epistemology through Elegant Reasonism which also links the rest of philosophy seeking truth aligned with a unified reality. Taking the individual MBP as a ‘system’ and architectures of them as “systems of systems” we link Systems Engineering. Taking the MBP as a fractal initiator we can link the Fractal Geometry of Nature. When we realize the affinity systems engineering has historically been avoiding we find that there was an intrinsic reason other such systems held the affinity they do. We can easily link such dynamic architectures from inorganic to organic system through action of such systems. Economics then is linked through the work of Ludwig Von Mises via action and Elegant Reasonism. In hind sight we should not be shocked that such affinities would come with the unification of physics but I must confess they shocked me. The Emergence Model of Particle Physics is included in this patent application, not as “the” model which unifies physics. Rather it is includes as ‘a’ model which unifies physics and because this method requires the use of such a model. M5 is offered here not as the ultimate model, but a model which can be used by subsequent investigations to comply with the requirements of this patent. Any other model closing to unification may be used, with or along with, M5.

### Emergence Model Rules

The following rule set govern The Emergence Model of Particle Physics:
The intrinsic nature of MBPs establishes the fundamental nature and character of this interpretive model of the Universe.
The intrinsic nature of MBPs derives two basic processes:
   The Fundamental Entanglement Process, or ‘build’ process is responsible for all configurations of architectural mass through which the manifestations of the physical properties arise. Because, by definition, MBPs may entangle with at most two other MBPs each, they tend to form strings which then follow Knot Theory to the limits of Severance. Such configurations are completely consistent with Euler's Beta and Gamma functions deriving convergence, a residue of which is responsible for polarization of character (of any given appropriate architecture). Because MBPs are the basic element of every configuration of architectural mass they represent a “fractal initiator” within the Fractal Geometry of Nature, and we can therefore show that the Universe is in essence ‘a fractal’ of wondrous complexities.
   The Severance process is the ‘failure mode’ of the build process and is responsible for configurations of MBPs decomposing into constituent MBPs. Severance is responsible for many aspects observed in science from the constancy for the speed of light to interaction of biological systems everywhere. Severance also sets up a completely unanticipated aspect of architectural mass making it under certain conditions frangible exactly because any condition exceeding Severance for any configurations of MBPs will cause such configurations to decompose. They can behave in no other manner because Severance is part of their intrinsic nature. Once we comprehensively comprehend the frangibility of architectural mass when such mass is subjected to energies exceeding its Severance values we quite suddenly realize we can describe the entire Universe Bang to Bang.
M5 defines ‘space’ as dimensionless nothing, and it therefore has no bearing or influence in any discussion, potentially excepting how far some real object must travel relative to another real object. It is otherwise completely irrelevant. What is important are the distances separating real objects and the actions associated with the intervening action displacement indices. It is therefore important to create Event Frames referencing real objects whose relationships to each other might be described as ‘discontinuous’ across such distances in such frames of reference.
M5 defines ‘time’ as an ‘action displacement index’ of dynamic architectural mass in an Event Frame. Action requires architectural mass in order to exist. While paths taken by architectural mass may result in a reversal of previous action such action is always positive and it is for that reason the “arrow of time” always flows forward and never in reverse. “Time travel” is therefore moot. Action displacement indexes are always positive. Because of this definition, action is required in order for time to exist, therefore the only time that is of any import is “now”, “instant to instant”. Time is the sequencing of the indexes of dynamic architectural mass in an Event Frame. Because all MBPs in every configuration of architectural mass have the same intrinsic nature, every such complex composite architecture so derived also has the same Severance values and it is this which is responsible for the constancy of time, not dimensional linkages to a construct on the other side of an interface which cannot be transited absent conversion to energy. This example also serves to illustrate how Elegant Reasonism illuminates clues from the depths of logic traps to avoid The Langer Epistemology Error.
M5 extrapolates, through ‘mode shifting’ The Standard Model of Particle Physics, The Emergence Model of Particle Physics. Therein the force of ‘gravity’ is made manifest by a particle called the graviton. Gravitons are polarized “high mass” to “low mass”. The graviton seeks mass and draws it toward its anchor point and its force is therefore perceived relative to the higher mass. However, at large distances the graviton senses more mass behind it than it does in front of it and at that point it flips 180 degrees. Pressure exceeding those experienced due to distance will turn it around again. Converging black holes at great distance on collision vector are an example. First they repel each other but their iMomentum exceeds Severance of the gravitons and the relative and respective gravitons ‘flip’ from repel to attract (they change their polar direction) and the black holes now follow the Event Frame Phase Steps outlined in the table covering the Event Frame Phase Step Taxonomy. When this happens common poles are presented between all such high mass objects, and they tend to repel each other due to this effect of the graviton. Galaxies and high mass super black holes then repel each other at these extreme distances. The resulting acceleration is also important relative to the Big Bang because it establishes the fundamental “Bang to Bang” realization from the frangibility of architectural mass due to Severance.
MBPs, in M5, have three states; 0, 1, and 2. State zero MBPs have no energy and are motionless relative to all other objects. State 0 MBPs have no energy with which to entangle into any configuration. State 1 MBPs have the energy necessary for the Fundamental Entanglement Function to configure complete its work, when encountering other MBPs. Multiple MBPs must be present creating a source pool such configurations manifest. State 2 MBPs have energies exceeding Severance values for all configurations and will therefore not entangle into configurations until such energies dissipate. These state changes are responsible for the science of thermodynamics.
The Emergence Model of Particle Physics is a product of the Elegant Reasonism process and method described holistically herein but more than that it also conforms to and is responsible for Elegant Reasonism as an epistemology which derives truth as a function of a unified reality. As an epistemology Elegant Reasonism reinforces belief systems derived from such truth and it decomposes those that are not. It has in that context a tendency to be “self-clarifying”.

### The Event Frame

The reference frame describing all action of, or between, any configurations of MBPs is the Event Frame. The Event Frame allows all real objects to be represented by a smooth discontinuous geometric map. Local frames, by definition, describe non-interacting configurations of MBPs in isolation surrounded by space. An Event Frame may integrate Local Frames and all Frames may be nested within one another to depict complex architectures and relationships. Event Frames are characterized by seven ‘Phase Steps’ which describe the transfer of material from the source to its ultimate merger with the body under investigation. The Event Frame is scale invariant in that its references or behavior does not change with scale. The geometric basis point of the Event Frame is any MBP, or set of them, in the frame. Because of the manner in which M5 is defined, all forces in the frame are fully coupled within the frame. This is the first time in human history any model of the Universe has accomplished this concept.

### The Event Frame is “Fully Coupled”

Vitally important is that the reader understand that because The Emergence Model develops the MBP as its basis that the geometric basis point of the Event Frame is some MBP or set of them in the frame. This is not a trivial nor trite point. Stephen Hawking in his 1975 seminal paper on black holes noted that any theory unifying physics, must place 100% of its context and abilities into what he called a “fully coupled” environment. What he means by that is that any given concept or phenomenon must be described relative to the geometric underpinnings or basis of the model and frame and must be capable of manifesting everything in the frame. M5, is fully coupled across all Event Frames across all scales.

If you have any two bodies in space moving they must be described in a way that demonstrates them sharing a common geometric basis point on which they move is based. All matter and radiation are perceived as configurations of MBPs represented by complex numbers as described here. Hawking's point was that a fully coupled system must be developed that rationalizes the complete and inclusive systems that include every facet and underlying intrinsic nature of the entire system, not just parts of it and M5 does exactly that. The Emergence Model is fully coupled and the traditional constructs, as Stephen Hawking noted, are not. [8] Once the implications “sink in” we realize that the geometric basis point of the Event Frame shifts focus away from spacetime and onto the system of MBPs in the frame consistent with the body of this work. Remember, space is nothing and as such there is nothing there to couple. What must be coupled are the configurations of MBPs. The profundity becomes epic when we realize “fully coupled” Event Frames can encapsulate the entire Universe and do so “bang to bang.” The profundity of this cannot be understated. Because these same processes are responsible for creating configurations of MBPs beyond the threshold of perception we are required to include in our skill set; concepts and tactics traditionally only used by the Information Technology industry disciplines in Systems Engineering.

Here these skills are applied to the physical Universe and everything in it. Saliently these processes require us to be able to position, discuss and debate these issues relative to the realm of the universe in which we exist both logically and physically. To do that in a more concrete and quantifiable manner requires another construct to be borrowed from the Information Technology industry. That of the “IP Translation Table”. Herein though we are not coupling human readable addresses to machine-readable ones. Rather we are coupling the paradigms common to all models of the Universe both logical and physical in a manner they can be compared and contrasted to and from each other.

### The Event Frame Phase Step Taxonomy

Generally speaking, “interaction”, in the context of M5, deals with multiple architectures of mass. Most are locally in motion, many in motion relative to other architectures. The Event Frame Phase Steps begin at index point zero (most directly up stream from the event under investigation. The Event Frame is scale invariant in the sense that these seven phase steps do not change as a function of any scale.

TABLE 3
Event Frame Phase Step Taxonomy (T:36)

| Phase | | | | | Predominant |
|---|---|---|---|---|---|
| Step | Name | Description | Begins | Ends | Action |
| EFPS1 | Event Frame | LF1 Body Event Acquires | Energy cascading | Geodesic | Severance of LF1 |
| | Phase Step One: | Energy which normalizes | toward Severance | Cruise Starts | leading to emission of |
| | The Event | causing Severance of LF2 | initiates | | LF2 |
| | Frame Begins | | | | |
| EFPS2 | Event Frame | Intervening flight from | Geodesic | LF3 Merger | Interval of LF2 |
| | Phase Step Two: | origin to destination- | Cruise Starts | Interlock | (analogous to |
| | Flight | bounded by Space | | Occurs | spacetime interval) |
| EFPS3 | Event Frame | Architectural Penetration | Earliest moments of | Physical | Merge Initiates: |
| | Phase Step Three: | & Interlock assures | Real Vectors (Lgcl to | Interaction | LF2 + LF3 begins |
| | Capture | capture of Preonic | Phys Shift Transition) | with LF3 | |
| | | Interface? | | | |
| EFPS4 | Event Frame | LF3′ Event Frame | Physical Interaction | Maximum | Harmonic Feedback |
| | Phase Step Four: | Thermodynamic | | Energy | during the merge |
| | Interaction | Normalization LF2-LF3 | | | |
| EFPS5 | Event Frame | Point of | System(s) Maximum | System | Thermodynamic |
| | Phase Step Five: | maximum action. | Energy | Maximum | Merge: |
| | Maximum | | | Energy | Perimeter(s) created |
| | Energy | | | Release | in voluminous bodies |
| | | | | | (absorption) |
| EFPS6 | Event Frame | Normalization of energy | Post Maximum | Energy | LF2 + LF3 = LF3′ |
| | Phase Step Six: | and merged materials | Energy Release | Release | (absorbed) |
| | Subsidence | | | Normalized | |
| EFPS7 | Event Frame | Long term chemical and | Thermodynamic | Present | LF3′ Perimeter |
| | Phase Step | physical normalization | Normalization | | Endures (material) |
| | Seven: | | | | |
| | Endurance | | | | |

### The Local Frame (LF)

Any discrete MBP system bounded by Space can be said to have an arbitrary “Local Frame” associated with it. The basis for any frame must “something” in that frame and the frame must have a ‘real’ geometric basis point or it does not exist in reality. You may ascribe an imaginary point other than the real geometric object in the frame; but the frame must contain a real object (e.g. a Reality Object). Otherwise any construct is not “real” and has no “basis”. We have to be careful here not to fall into the trap of orthodoxy here by considering larger systems of subatomic particles as “MBPs”. They are not. Quarks, Leptons, Bosons, and all the other particles generally considered to be part of The Standard Model of Particle Physics are “systems of MBPs”. These systems are likely comprised of some configuration of MBPs which have formed Prime Knots (Knot Invariants) which are in turn entangled into these larger structures. (e.g. quarks, virtual particles, etc.) One such particle is the photon and it represents a good example particle to use in our considerations of the Local Frame. Historically, and traditionally, orthodox teaching generally refers to subatomic particles as “point mass” or “point particles”. We don't do that here. Here every particle is a recognized structure, whether or not we actually have a description of its internal organization. At this juncture we don't have any description of any structures. What we do have though are a great many clues that have to be organized about each of the various particles so that we might begin to formulate candidate structures representing each particle of The Standard Model of Particle Physics. Each of these descriptions must be consistent with the equation for mass.

TABLE 4
Local Frame Taxonomy (T:29)

| Local Frame | |
|---|---|
| Nomenclature | Description |
| LF1 | Originating Frame “Pre-Severance”. This is the frame |
| | into which energy is injected which produces emission |
| | of the Reality Structure within LF2. |
| LF2 | Contains the discrete Reality Structure in EFPS2 bounded |
| | on all sides by Space and can therefore be considered a |
| | discrete structure whose only ‘real’ geometric basis point |
| | is within the structure itself. |
| LF3 | Generally considered the ‘interactive’ Frame containing |
| | all relevant interacting particles or bodies, prior to EFPS7. |
| | LF3 is the relevant dynamic portion of the Event Frame |
| | local to investigation. |
| LF3′ | Generally considered the ‘post-merge’ Event Frame con- |
| | taining all relevant materials from all objects enduring in |
| | the frame. Objects which have been severed from the |
| | frame are not included here because they no longer im- |
| | part any influence. |

So in an imaginary Event Frame one may have multiple particles each of whom have imaginary parts that are characterized as being in their own LF2 state. Once ‘interaction’ begins those imaginary parts become ‘real’ parts and the Event Frame is then characterized as being in LF3 but may have outstanding LF2 constituents that are being investigated in a given model. Once the merge has happened and all constituents are seeking thermodynamic equilibrium LF3′ then describes the endurance phase EFPS7.

### Other Enumerated Encapsulated Interpretive Models

There are seven reserved “model” enumerations M1 through M7, with M7 held in reserve for historical reasons. Any subsequently defined model is considered a derivative work since it requires recognition of the nature of predominate thinking prior to this patent. Highly simplistically the currently enumerated various models are:
M1: Predominant modern relativistic thinking where mass is variant.
M2: Einstein's original thinking where mass is invariant.
M3: Both M1 and M2 are logical views. M3 is reserved for a physical view of either M1 or M2. The spacetime-mass interface generally precludes much relevant R&D because of the way these models are fundamentally defined. Consequently none of these three models will ever unify physics.
M4: is a reserved “emulation mode” of M5 where certain parameters may be set to values allowing M5 to behave as either M1 or M2 depending on how the values are set across the domain of discourse.
M5: is the logical view of the Emergence Model of Particle Physics.
M6: is reserved for future work on the physical views of the Emergence Model.
M7: is reserved in case worldwide consensus wishes to realign the previous model enumerations to preserve the requirement that all models have both a logical and a physical view. In that case M1 would become the logical view of M2's physical view. M3 would become what is currently defined as M2 and M4 would be that model's physical view. M5 would become the emulation mode of M6. The Emergence Model would then become models M6 and M7. This realignment was never carried out in our body of work because of historical momentum was already behind the previously listed sets and it was deemed of no real value. We articulate this here for historical purposes and correctness. M7 is therefore simply “reserved”.

NOTE: Actual model enumeration generally refers to the entire set of iterated models whose basis is in alignment with the descriptions in the above list. M1 therefore actually has a number of iterated models labeled M1.0000, M1.0001, . . . , etc. Once defined no model may change in any way as a matter of rigor and discipline. If it is determined that the model must change for any given reason it is iterated rather than changed and the changes are integrated into the subsequent iteration. This preserves history and previous contemplations. It also provides clarity and integrity of communications as the specific interpretive model iteration should be listed as the basis for all communications. My company therefore strongly recommends that a global database be established exactly for the purposes of assuring the integrity of investigations and team communications worldwide. Such a database and the resulting investigations represent the single largest computing opportunity humanity may ever have.

### An Abbreviated Elegant Reasonism Treatise

The following is an abbreviated Elegant Reasonism based Treatise from the body of work this patent application represents. This brief treatise is the result of Elegant Reasonism at work. Civilization, until the filing of this patent application, failed to unify physics in any real manner despite considerable effort to do so. Taking special heed of Einstein's own comment that “we cannot solve problems using the same thinking we used when we created them”, we are motivated to back up and conduct a thorough systems review across the record of history to the present day.

The requirements for “unification” are:
100% of the fundamental forces of nature must be illustrated in terms of one another in a common manner. M5 describes all forces as a function of the work performed by actions of architectural mass in an Event Frame.
All real objects must share a common geometry. M5's nature and character is derived from a Most Basic Particle (MBP) which it, or any set of which, may act as the geometric basis in all frames of reference across all scales.
All real objects in every reference frame must be “fully coupled” by that frame to the holistic descriptions governing them. Everything real in M5 is some configuration of MBPs forming architectural mass whose constituents manifest all forces governing every action across all scales fully coupling all real objects in every frame of reference.
All descriptions must be scale invariant. Because all real objects of every size are complex composite configurations of MBPs they are intrinsically scale invariant.

M5 therefore unifies physics for the first time in history. As powerful as the previous sentence may be, what is more powerful is the process and method which accomplished the feat and that, is, for the first time, revealed as a function of this patent application. Analysis of M1, M2, and M3, as previously described finds that they each have the same core constructs; energy, mass, and spacetime. M5, on the other hand has essentially a single construct, the MBP. Since space, by M5, is considered ‘dimensionless nothing’, it is irrelevant in every discussion because it cannot influence anything. Predominant thinking today (circa 2019) is demographically parsed between M1 and M2, with the modern majority beholden to M1. Both M1 and M2 are logical views on the physical system of unified reality. We then are faced with the fact that logically correct views can be based on physically different systems. What we are left with must be that the distinctions in detail are the reasons these models in particular do not unify physics. We then investigated their core constructs and ultimately come to the mass-energy equivalence concept which is tied to spacetime via the geometric relationship to those model's rule set governing the speed of light relative to the geometry of spacetime. Examination of M1, M2, and M3 results in awareness of the “spacetime-mass interface” across which no mass (e.g. real matter) may traverse without first transforming into energy thus preventing and precluding the use of any common geometric basis point. The implication of this single fact is that these models do not just “not unify physics”, none of them ever will exactly because of this condition. M5 does not have this issue because of its treatment of space as ‘dimensionless nothing’. Furthermore any MBP in M5 or configuration of them may act as the geometric basis point for every real object in any frame. All real objects in M5 therefore can share the same basis point. This leaves us with how M5 answers the same constancy issues originally sought after by M1, M2, and M3. When we see the imposition of dimensions by M1, M2, and M3 we must observe that the ‘imposition’ is due to the rule set governing the relationship between the speed of light and spacetime. That relationship is external to the core constructs of these models. M5 derives its basis from an MBP and the fundamental processes therein are derived from their intrinsic nature. Any review of that description, included herein, finds the ‘failure mode’ process called Severance. Because the Severance value for all essentially equivalent architectures of mass is the same—all similar particles (e.g. architectures) ‘Sever’ at the same energies and in similar manners. This is why all photons leave electrons at the same velocity. It has nothing to do with any external imposition on them and everything to do with the internal systems producing them. We can drop back to one of the standard areas of inquiry into unification, using M1, M2, or M3, involving the phenomena of gravity. There are several aspects of the manifestation of this phenomena (gravity) by these models. Gravity in M1, M2, and M3 is said to be a phenomena which results because “mass ‘warps’ spacetime”. There are implications of this which span the spectrum of science from the Big Bang to Black Holes, to simple gravity we experience every day here on Earth. M5 defines gravity as a function of an architectural particle called the Graviton, which is a particle within the Emergence Model of Particle Physics (essentially a version of the Standard Model mode shifted from M1, or M2, through Elegant Reasonism into M5). Any engineer will tell you that in order to bend or warp anything real that ‘real’ object must be able to posses several “properties of physics”. Properties like stress, tension, shear, friction, etc. Without these fundamental properties nothing real may be warped or bent, because the object would simply resist all attempts to manipulate it in any manner. Consider then, as defined by M1, M2, or M3, the concept of spacetime. That it cannot be warped absent these properties, requires us to integrate these properties into that construct in order to satisfy that requirement. We are then forced to realize that all mass must, by definition, warp all spacetime—including that at the quantum level, because the model requirement must be scale invariant. Quantum gravity still eludes modern science employing M1, M2, or M3. M5 deals with these issues as a function of architectural configurations of MBPs. All physical properties manifest as a function of complex composite architectures which are simply different configurations of MBPs (therein following Knot Theory due to the intrinsic nature of MBPs). The definition of M5 intrinsically unifies all forces. Furthermore, any review of the definition of M5 included herein will show that M5 is the reason Isaac Newton's laws are true. Asking ‘why Newton's laws are true’ and answering ‘Force equals mass times acceleration’ is in essence a contextual answer based on the logical interpretation of the core constituents of M1, M2, or M3. It doesn't really answer the question asked. M5 intrinsically answers the question intrinsically through its definition. Space, in M5, is dimensionless nothing and therefore cannot influence anything. We are therefore required to realize that all force results from the action of architectural masses upon one another and in the context of M5. All the facets of Newton's arguments resonate in and by M5 finding truth from a unified Universe. Each of Newton's laws can each be reviewed in exactly this same manner. Gravitons, in M5, are ‘low order’ constructs relative to configuration complexities across the spectrum of such architectures. They are constituents of almost all higher ordered constructs. Gravitons are polarized along ‘high mass’—‘low mass’ gradients. Gravitons can entangle with each other and extend range within the limits of Severance for those architectures. At great distances there is more mass ‘behind’ the graviton than there is in front of them. Under such extreme conditions they rotate 180 degrees in order to satisfy their intrinsic polarization nature. Just like in electromagnetism like poles repel. This is why galaxies accelerate away from one another at those distances. This same example illustrates scale invariance of M5. The body of work this patent application represents has reviewed some 403 equations, produced over 2,000 pages of raw insights all produced by the methods articulated in this patent application. These few examples are the merest fraction of those available, and they span science. The patent trial process will likely explore more than several of these, and we are happy to accommodate. When we take the methods producing these insights and isolate it from the tremendous results we find a powerful and unique epistemology, method, process and tool. It is these aspects, along with M5, from the body of work conducted that this application process submits for patent, to include all derivative works.

### Elegant Reasonism Conclusion—35USC112(b)

Humanity exists, as an intrinsic part of the real unified Universe. Until this patent application our species had no mechanism, method, process, manner, or epistemology in which to describe that unified universe or how we manifest within it, and Elegant Reasonism reconciles that deficit as a function of this patent, and the various derivative works based on it or any part thereof. Elegant Reasonism seeks truth from the real unified Universe pursuing a plurality of interpretive models holistically capable of articulating that truth with the goal and objective of instantiating a cogent epistemological approach consistent with scientific principle and methods. Salient within the epistemological approach here is that human paradigms manifest as real neural networks. Change your thinking and you change those networks. Mathematics is preserved as a science while the parameters associated with individual interpretive (encapsulated) models remain contextual to the relative the respective models. Elegant Reasonism establishes linkages and relationships between the simplest elements of such models to their most complex and driving affinity all the while with the actual real unified Universe. The example interpretive model providing a unified view of the Universe, for the first time, is The Emergence Model and its logical view M5. M5 is a product of Elegant Reasonism. M5 is therefore an example result of this method, process, and epistemology. M5 is foundational and highly systemic. M5 links quantum mechanics and cosmology for the first time in recorded history exactly because the standards, rules, and processes, apply isotropically across all scales. Truth delivered as an aligned function of M5 relative to the real unified Universe is powerful beyond words. Elegant Reasonism delivers unprecedented clarity achieved in no other way. The more M5 is studied the stronger it gets. That Elegant Reasonism delivers such results is an example in and of itself to its unique, patently demonstrable, value to civilization.

### BIBLIOGRAPHY

1: Langer, Susanne K., Philosophy in a New Key: A Study in the Symbolism of Reason, Rite, and Art, Harvard University Press, ISBN: 1948
2: Ludwig von Mises, Human Action—A Treatise on Economics, Irvington-on-Hudson, N.Y., The Foundation for Economic Education, Inc., ISBN:1-57246-021-0, 1949
3: Wald, Abraham, Statistical Decision Functions, Wiley, ISBN: 1950
4: Bernardo, Jose M., Smith, Adrian F. M., Bayesian Theory, John Wiley, ISBN:0-471-92416-4, 1994
5: Pearl, Judea, Causality: Models, Reasoning, and Inference, Cambridge University Press, ISBN:978-0521895606, 2009 Sep. 14
6: Mitchell, Tom M., Machine Learning, McGraw-Hill, ISBN:0070428077, 1997
7: de Bono, Dr. Edward, Six Thinking Hats, Back Bay Books, ISBN:978-0316178310, 1999
8: Hawking, Stephen W., Particle Creation by Black Holes, 1975

1. Elegant Reasonism is a unique methodology resulting in a new epistemology employing standards based principles seeking truth aligned with a unified Universe (e.g. unified reality).

2. Elegant Reasonism provides, and offers, an encapsulated interpretive model, The Emergence Model, which closes to unification and satisfies process requirements requiring at least one such model be employed by the process.

3. Chart 5 in the DRW_00 file outlines the generalized process flow and illustrates the generalized three parts of the patent.

4. This patent, its processes, has produced a body of work which will be subsequently released upon approval and granting, some enumerated 2,200 pages, to help others comprehend implications of committing THE LANGER EPISTEMOLOGY ERROR.
